(19) United States
(12) Patent Application Publication
(10) Pub. No.: US 2015/0026037 A1
(43) Pub. Date: Jan. 22, 2015

(54) SYSTEM, METHOD AND APPARATUS TO PROVIDE A MULTI-CHANNEL RETAIL LAYAWAY SERVICE USING PHYSICAL RETAIL POINT-OF-SALE AND ON-LINE VIRTUAL PAYMENT SYSTEMS

(71) Applicant: LayAwayBuddy, LLC

(72) Inventors: Terrace Barrell Thompson, Queen Creek, AZ (US); Warren Keith Thompson, Oklahoma City, OK (US)

(73) Assignee: LayAwayBuddy, LLC, Queen Creek, AZ (US)

(21) Appl. No.: 14/327,835

(22) Filed: Jul. 10, 2014

Related U.S. Application Data
(60) Provisional application No. 61/958,094, filed on Jul. 19, 2013.

(51) Int. Cl. G06Q 40/02

(52) U.S. Cl. CPC G06Q 40/025
USPC 705/38

(57) ABSTRACT

A system, method and apparatus for facilitating a value exchange transaction and virtual payment system to provide retail layaway services. A registered buyer may use an on-line retail channel or a physical retail channel to form a layaway contract. The buyer simultaneously executes a debit and credit transaction at an on-line retail or physical retail channel to purchase one or more ordered items from registered or non-registered sellers while making an initial down payment. The items are then shipped to a secure storage facility for the duration of the layaway contract period making the retail sales final. Upon completion of the terms of the formed layaway contract, the ordered items are shipped from the secure storage facility 118 to the buyer's final shipping address 119. Canceled layaway transactions are made available for layaway, direct purchase, or purchase via an open on-line auction.

### REFERENCES CITED

U.S. PATENT DOCUMENTS

| | | | |
|---|---|---|---|
| 7,870,055 B2 | January 2011 | Fisher, et al. | 705/37 |
| 7,908,226 B2 | March 2011 | Hutchison, et al. | 705/79 |
| 8,386,337 B2 | February 2013 | Siegel | 705/26.8 |

U.S. PATENT APPLICATION DOCUMENTS

| | | | |
|---|---|---|---|
| 0,289,006 A1 | November 2011 | Hutchison, et al., | 705/79 |
| 0,046,958 A1 | February 2012 | Pynadath, et al., | 705/1.1 |

U.S. PROVISIONAL PATENT APPLICATION DOCUMENTS

| | | |
|---|---|---|
| 61/958,094 | July 2013 | Thompson, et al., |

### FIELD OF THE INVENTION

The subject invention generally relates to computer-based and physical or “brick and mortar” retail services and, more particularly, relates to systems and methods for providing these multi-channel retail layaway services.

### BACKGROUND OF THE INVENTION

U.S. Pat. Appl. US 2012/0046958 A1 describes multi-channel layaway services whereby a customer may use an on-line retail channel or a linked physical or “brick and mortar” retail channel to form a layaway contract to purchase one or more ordered items and then use the on-line retail channel and/or the physical retail channel to make payments on, view, or otherwise manage the formed layaway contract. Upon completion of the terms of the formed layaway contract, the customer is able to receive the ordered items. By way of example, eLayaway, Inc. provides a retail layaway service that, like traditional retail layaway services, allows a customer to make payments overtime for items only ordered on-line from a registered merchant. The customer can interact with an on-line calculator to customize the size of the monthly payments by adjusting how many payments are desired. The system then functions to automatically deduct the monthly payments from a specified bank account. When all of the payments have been made, the merchant will ship the items ordered to the customer.

U.S. Pat. No. 7,908,226 and U.S. Pat. Appl. US 2011/0289006 A1 discloses a virtual payment system for ordering and paying for goods, services and content over an internetwork. The virtual payment system is a secure, closed system comprising registered sellers and buyers. A buyer becomes a registered participant by applying for a virtual payment account. Likewise, an on-line seller becomes registered by applying for a seller account. A buyer can instantly open an account on-line. Once an account is established, a digital certificate is stored on the registered participant's computer. The buyer can then order a product, i.e., goods, services or content from an on-line seller and charge it to the virtual payment account. When the product is shipped by the seller, the charges are applied to the buyer's virtual payment account. The buyer can settle the charges using a prepaid account, a credit account, or by using reward points earned through use of the virtual payment card.

The contents of the above mentioned publications are incorporated herein by reference in their entirety.

### SUMMARY OF THE INVENTION

The following describes system, method, and apparatus for providing a multi-channel layaway service, i.e., a retail layaway service to which on-line retail channels and physical or “brick and mortar” retail channels. The on-line and physical retailer channels do not have to be linked. The described system, method, and apparatus thus allow a registered customer to generate and use an on-line virtual payment account (VPA) for registered on-line retail channels and a VPA linked layaway purchase card (LPC) for non-registered online and registered physical retail channels to form a layaway contract to purchase one or more ordered items, ship items to a secure storage facility (this differs from normal layaway contracts in that the ordered items are not placed in holding stock, for example, at the physical retail store location and use the on-line virtual payment account to make payments on, view, or otherwise manage the formed layaway contract for the un-linked on-line and physical retailers.

While the foregoing provides a general overview of the some of the various features and functionalities of the subject invention, a better understanding of the objects, advantages, features, properties and relationships of the subject invention will be obtained from the following detail description and accompanying drawings which set forth illustrative embodiments and which are indicative of the various ways in which the principles of the subject invention may be employed.

### DESCRIPTION OF THE DRAWINGS

For a better understanding of the subject invention, reference may be had to preferred embodiment shown in the attached drawings which:

FIG. 1 is a pictorial diagram of an exemplary retail environment for forming a virtual payment account and layaway contract through an on-line retail channel using a local area network (LAN) connected to the Internet and through a physical or “brick and mortar” retail channel using a point-of-sale (POS) system.

FIG. 2 is a diagram illustrating the actions taken by a buyer's computer, the layaway contract management (LCM) server, the credit processing server, and identity bureau and a credit bureau to create a virtual payment account for a buyer.

FIGS. 3A-3H are exemplary web pages displayed on a buyer's computer when applying for a virtual payment account in accordance with the present invention;

FIGS. 4A-4B are exemplary web pages used by a buyer to customize the virtual payment account applied for in accordance with the present invention:

FIGS. 5A-5E are exemplary web pages used by a buyer to purchase goods from registered on-line retailers and manage layaway contracts on-line via the on-line layaway calculator;

FIG. 6 is a flow diagram illustrating the logic used by the buyer's computer to order goods, services and/or content from the Internet using the Web browser;

FIG. 7 is a flow diagram illustrating the logic used by a buyer authenticator of the buyer's computer to validate that the buyer is a registered layaway virtual payment account participant;

FIG. 8 is a flow diagram illustrating the logic used by an alternate buyer authenticator of the buyer's computer to validate that the buyer is a registered layaway virtual payment account participant;

FIG. 9 is a flow diagram illustrating the logic used by the buyer's computer to apply for a layaway virtual payment account using the Web browser;

FIG. 10 is a flow diagram illustrating the logic used by an enrollment server of the commerce gateway to establish a new buyer account in accordance with the present invention;

FIG. 11 a flow diagram illustrating the logic used by an account identification container generator of the commerce gateway to generate an account identification for a given transaction;

FIG. 12 is a flow diagram illustrating the logic used by a commerce engine of a seller computer to provide for the purchase, shipment and payment of layaway goods over the Internet;

FIG. 13 is a flow diagram illustrating the logic used by a commerce gateway adapter of the seller server to allow a commerce engine to communicate with a transaction server on the commerce gateway;

FIG. 14 is a flow diagram illustrating the logic used by the transaction server of the commerce gateway to process an order for goods, services and/or content over the Internet using a virtual payment account;

FIGS. 15 and 16 are flow diagrams illustrating the logic used by various subsystems of the credit processing server to provide for payment of goods, services and/or content ordered over the Internet using a layaway virtual payment account;

FIG. 17 is a diagram illustrating the actions taken by the buyer's computer, the seller server and the commerce gateway to purchase goods using the layaway virtual payment account;

FIG. 18 is a flow diagram illustrating the logic used by the seller's computer to perform a settlement transaction, i.e., initiate transfer of funds;

FIGS. 19, 20, and 21 are exemplary web pages used by a buyer to purchase goods from non-registered on-line retailers using the Layaway Purchase Card (LPC);

FIGS. 22A-22D are pictorial diagrams of the process used by a buyer to purchase goods from registered physical or “brick and mortar” retailers using the layaway purchase card and the retailers point-of-sale (POS) device;

FIG. 23 is a pictorial diagram of an example of a shipping label issued during the buyer's purchase of goods from registered physical or “brick and mortar” retailers using the layaway purchase card and the retailers point-of-sale (POS) device;

FIG. 24 is a flow diagram illustrating the logic used by the seller's computer to perform a settlement transaction, i.e., initiate transfer of funds;

FIG. 25 is a flow diagram illustrating the logic used by the transaction server of the commerce gateway to process a settlement transaction;

FIG. 26 is a flow diagram illustrating the logic used by the administrator's computer to initiate a partial refund to be applied to a virtual payment account in accordance with the present invention;

FIG. 27 is a flow diagram illustrating the logic used by the administrator's computer to initiate a total refund to be applied to a virtual payment account and transfer the layaway merchandise to the auction site for resale in accordance with the present invention;

FIG. 28 illustrates the web page for registered buyers to execute a single-action refunds;

FIG. 29 is a block diagram of components illustrating an exemplary embodiment of the present invention to allow registered buyers to purchase returned or canceled layaway merchandise via on-line auction;

FIG. 30 is a flowchart illustrating an exemplary bid validator and its method of operation;

### DETAILED DESCRIPTION OF THE INVENTION

The on-line system may comprise a communication server 105 that connects to the value exchange system to register new users and sellers, a layaway contract management (LCM) server 104 for conducting value exchange and virtual payment transactions on-line and a credit processing server 107 for setting up layaway virtual payment accounts (VPA) and financial servers 109 111 113 for interacting with external financial institutions 110 112 114. The LCM server 104 is comprised of web and transaction servers, account/billing and payment processing subsystems, and a credit processing server adapter. The LCM server is the commerce gateway of provider of the layaway virtual payment system that authorizes payments for e-businesses, online retailers, bricks and clicks, or traditional brick and mortar. When on-line 101, the buyer accesses the virtual payment account 104 from internet connected devices 101a-d to purchase one or more ordered items from registered sellers on-line web store 117 via the seller's server 102 and form a layaway contract. The seller's server 102 includes the commerce engine, an essential tool for the seller's web store, and a commerce gateway adapter. In the embodiment the internet connected devices 101a-d can consist of one or more of the following devices: desktop personal computer 101b, laptop computer 101d, tablet computer 101c, or smartphone 101a.

When at a non-registered on-line 102 117 or registered physical retail channel 116, the buyer can access the virtual payment account to purchase one or more ordered items from registered sellers and form a layaway contract through use of a combination layaway credit and debit card or “Layaway Purchase Card (LPC)” at the on-line retailer's web site or physical retailer's point-of-sale (POS) system 115.

In all cases, the purchased items are then shipped to a secure storage facility 118 during the term of the formed layaway contract making the retail sale final with the seller. Additionally, in all cases the buyer then uses the virtual payment account 104 to manage layaway contract and/or make additional payments, i.e., payments outside of the automatic payment withdrawals, via a prepay, debit or credit account on the remaining retail balance plus layaway and additional shipping fees, view, or otherwise manage the formed layaway contract.

A buyer connects to the value exchange system 105 through a secure internet connection to instantly open a virtual payment account on-line 104. After an identification check, the buyer then pays a registration fee that grants a minimum credit limit to the account. While executing the identification check, the credit process component 107 108 evaluates the buyer's virtual payment account application and may assign a credit limit to the virtual account higher than the minimum credit limit if the buyer qualifies.

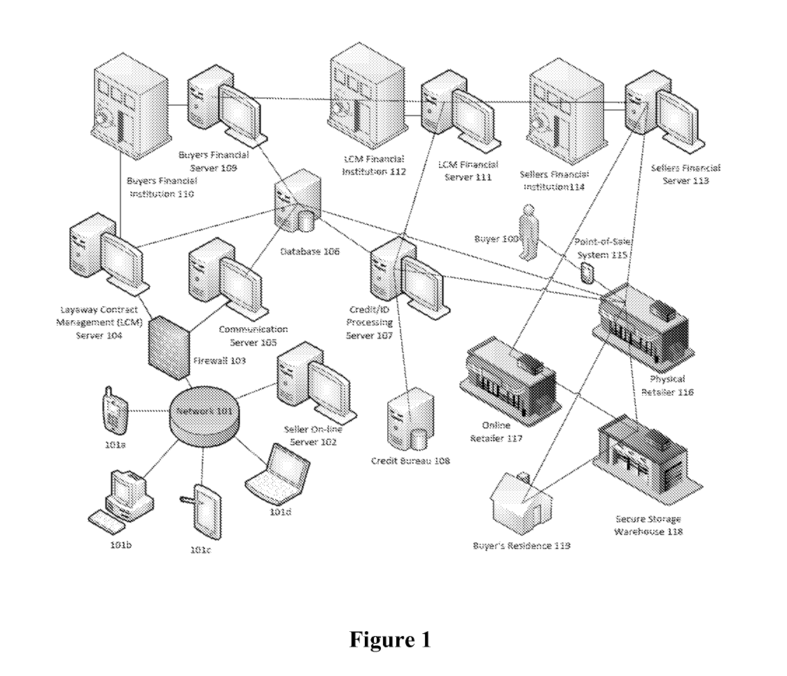

The system of FIG. 1 includes central database 106 which is configured to store various information and account/billing subsystem information for facilitating virtual payment account and layaway transactions. Illustratively, the information stored in the database 106 includes accounts for registered users of the system. User information for registered users may include user identifiers and enrollment data (e.g., name, electronic mail address, telephone number, network address, and physical address), payment processing and transaction records, account billings and balances, preferred communication methods (e.g., electronic mail, wireless voice), security data, etc.

After the accounts are set up, the buyer is issued a layaway purchase card (LPC) by mail that can be used to purchase items for layaway at an unregistered on-line retail channel 102 117 or at a registered physical retail channel 116.

When purchasing items at a registered or non-registered on-line retail channel 102 117 or at a registered physical retail channel 116, the buyer can purchase one or more ordered items from the sellers and charge it to the virtual payment account 104 111 112 while simultaneously and automatically deducting a set minimum down payment (e.g., ten percent of retail value plus shipping) by which the layaway transaction is made secure 109 110.

The items are then shipped to a secure storage facility 118 for the duration of the layaway contract period making the retail sale final. If the item is considered freight in size, the freight item can be stored at retailer's facility 116 for the duration of the layaway contract period for a set storage fee.

The virtual payment system then functions to automatically deduct the monthly payments on the remaining balance from a specified bank, debit, or credit account 109 110.

Upon completion of the terms of the formed layaway contract, the ordered items are shipped from the secure storage facility 118 or retailer's storage facility for freight items 116, to the buyer's final shipping address 119.

All credit for buyers with canceled layaway transactions will be suspended until layaway items are sold, after which, credit restoration will be at the discretion of the virtual account manager

Canceled layaway transactions are made available on-line to registered buyers for layaway purchase and to registered and non-registered buyers for direct purchase or purchase via on-line auction.

### Applying for a Layaway Virtual Payment Account (VPA)

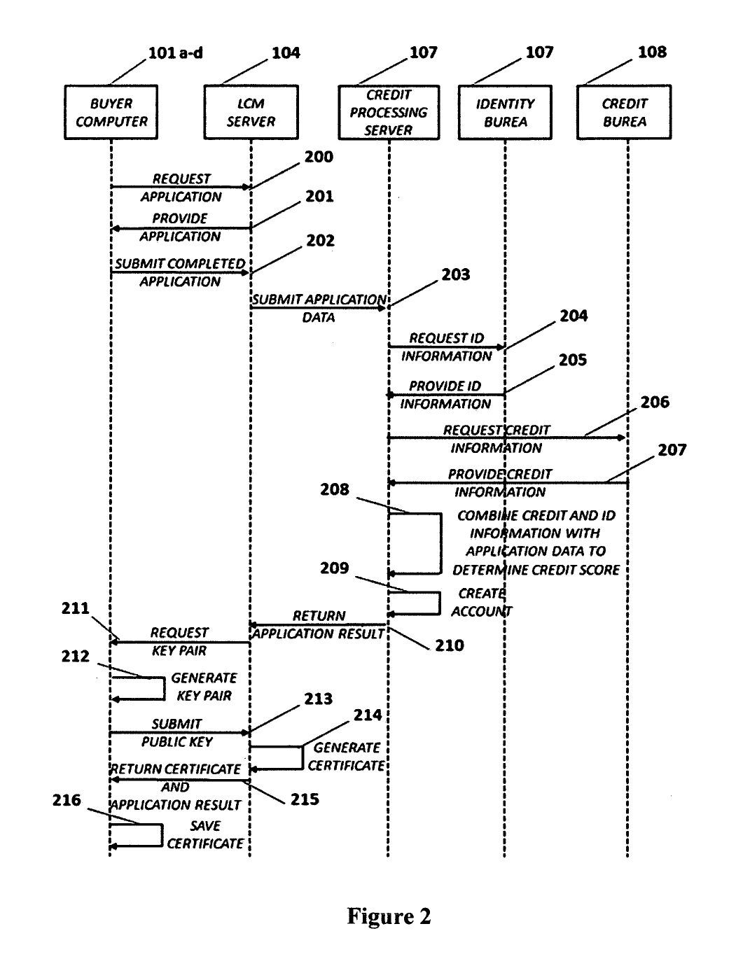

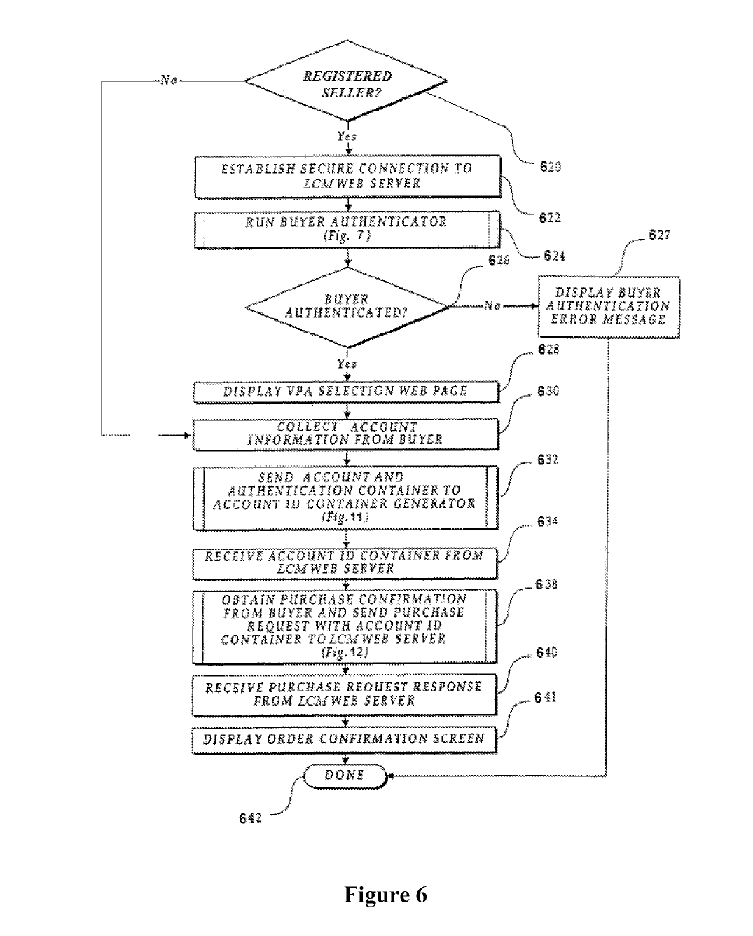

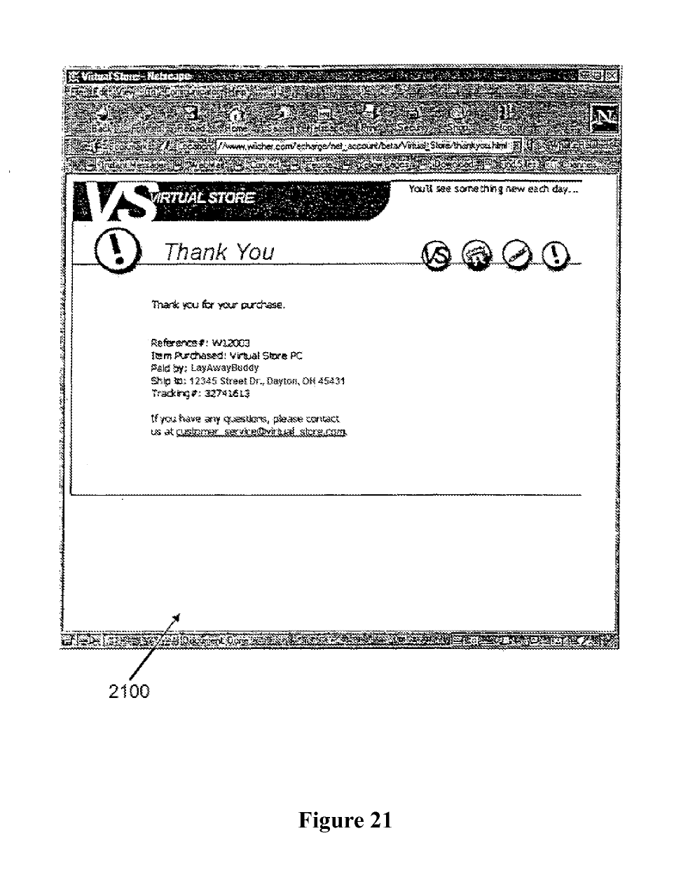

Once a VPA is set up, the virtual payment system of the present invention is a closed system that provides buyers a secure method for purchasing products over the Internet. The closed system includes only a registered buyer's internet connected devices 101a-d, a registered or non-registered seller server 102, the Layaway Contract Management server 104 (administered by the provider of the layaway virtual payment system) and the credit processing server 107 (which can also be administered by the provider of the virtual payment system). Since the account information necessary for charging the buyer for the purchase is already in the possession of the Layaway Contract Management server 104 and the credit processing server 107, the closed system of the present invention allows registered buyers to purchase products from registered and non-registered on-line sellers 102 117 and registered physical sellers 116 without transferring sensitive account information to the sellers over the Internet. In order to become a member of the virtual payment system of the present invention, a buyer becomes a registered user by obtaining a virtual payment account. FIG. 2 illustrates the actions taken by the buyer's computer 101a-d, the Layaway Contract Management server 104, the credit processing system 107, and the credit bureau 108 to create a virtual payment account for a buyer. The interactions of the various components are illustrated and described in detail later for various transactions performed by the present invention with reference to the diagrams shown in FIGS. 6 and 21. As shown in FIG. 2, the process of applying for a virtual payment account is initiated when a buyer requests 200 an application form via the Internet 101 using the Web browser installed on the buyer's Internet access device 101a-d. The buyer may apply for a virtual payment account directly from a virtual payment account Web site located at the Layaway Contract Management server 104 or indirectly from a registered seller site located at the seller server 102. Once the request 200 for the application form is received by the Layaway Contract Management server 104, the Layaway Contract Management server 104 provides buyer internet connected device 101a-d the application form 201 via e-mail so that the buyer can complete the form displayed in the Web browser of the buyer internet connected device 101a-d.

Upon completion of the application form, the buyer internet connected device 101a-d submits the completed application form 202 to the Layaway Contract Management server 104. The Layaway Contract Management server 104 then submits the application data 203 from the completed form to the credit processing server 107 for account and credit limit authorization. The credit processing server 107 verifies the application data by requesting identity information 204 from an identity bureau 107. The identity bureau 107 provides the requested identity information 205 and if the provided identity information corresponds to the application data then the credit processing server 107 requests credit information 206 about the buyer from a credit bureau 108. However, in one actual embodiment of the present invention, if the application data does not conform to the identity information from the identity bureau 107, then no virtual payment account is created and the application is forwarded to customer service for review for possible fraud detection. As noted above, in the actual embodiment of the present invention, the identity bureau 107 is a server provided and maintained by an agency for verifying identity and the credit bureau 108 is a server provided and administrated by a credit agency for processing credit reports. Hence, the credit processing server 107 requests the desired identity and credit information electronically, e.g., via appropriate database queries, etc., from the identity bureau 107 and credit bureau 108.

Returning to the illustrated embodiment, the credit bureau 108 provides the requested credit information 207 to the credit processing server 107 via the connection with the credit processing server 107. The credit processing server 107 then evaluates the application, identity and credit information by combining the identity information from the identity bureau 107 and the credit information received from the credit bureau 108 with application data in order to determine a credit score 208. If the score exceeds a certain threshold, a credit limit is set and the virtual payment account is created 209. If the score falls below the threshold, a virtual payment account may still be created 209, however, with a minimum credit balance and higher interest rate. Customers may also contact a customer service representative for account review for a possible grant of higher credit.

Once the virtual payment account is created, the credit processing server 107 returns the result of the evaluation 210, e.g., approval/denial, credit limit, etc., to the Layaway Contract Management server 104. The Layaway Contract Management server then requests 211 that the buyer authenticator within the buyer's internet connected device 101a-d generate a public key encryption key pair 212 comprising a secret key and a public key. The buyer authenticator then submits the public key to the Layaway Contract Management server 213. The Layaway Contract Management server 104 digitally signs the public key to generate a digital certificate 216. As will be appreciated by those of ordinary skill in the art, a digital certificate comprises a public key digitally signed by a trustworthy entity. The Layaway Contract Management server 104 sends the digital certificate and an application result page 215 to the buyer's internet connected device 101a-d for display via the buyer internet connected device's Web browser. Finally, the buyer internet connected device stores the digital certificate 216 for use later with the virtual payment account.

It will be appreciated that the digital certificate may be stored in the memory of the buyer internet connected device 101a-d, or on some form of device capable of interfacing with the buyer internet connected device such as but not limited to a secure token, smart card or as an encrypted file on some other computer readable medium. It will be appreciated by those of ordinary skill in the art that the order of the operations in FIG. 2 may be altered without substantially affecting the operation of the present invention. For example, the buyer may be notified of the application results before generating the public key encryption pairs.

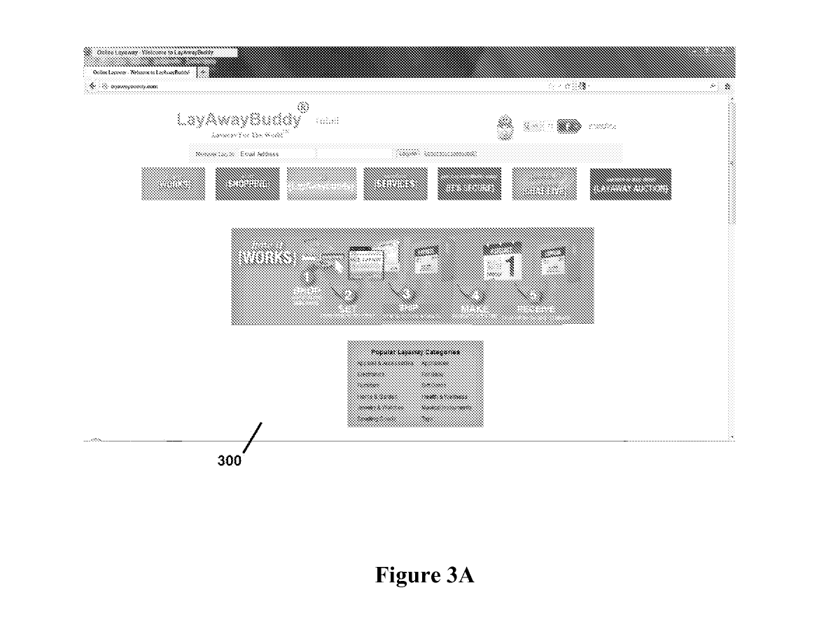

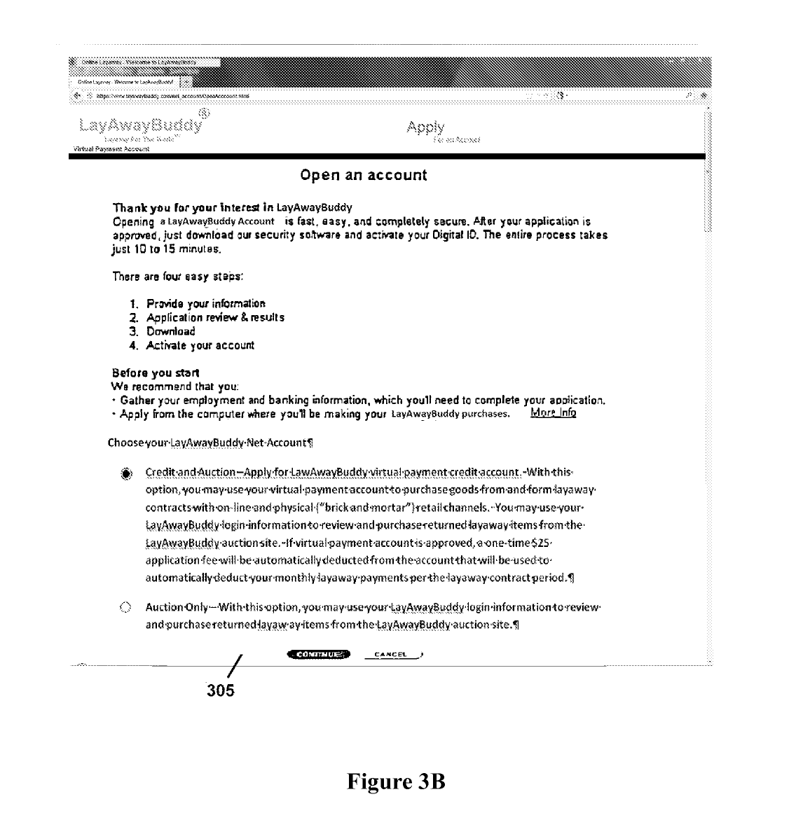

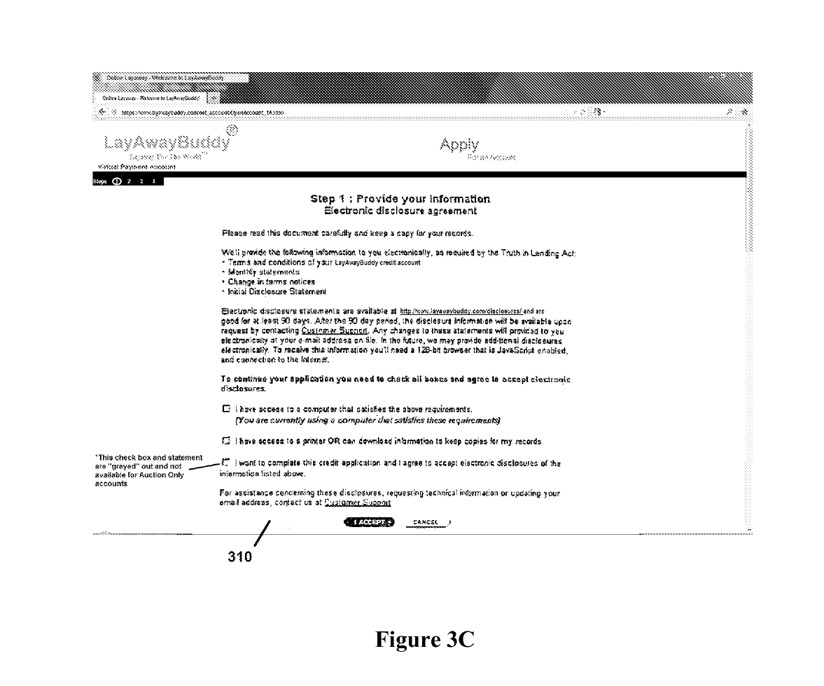

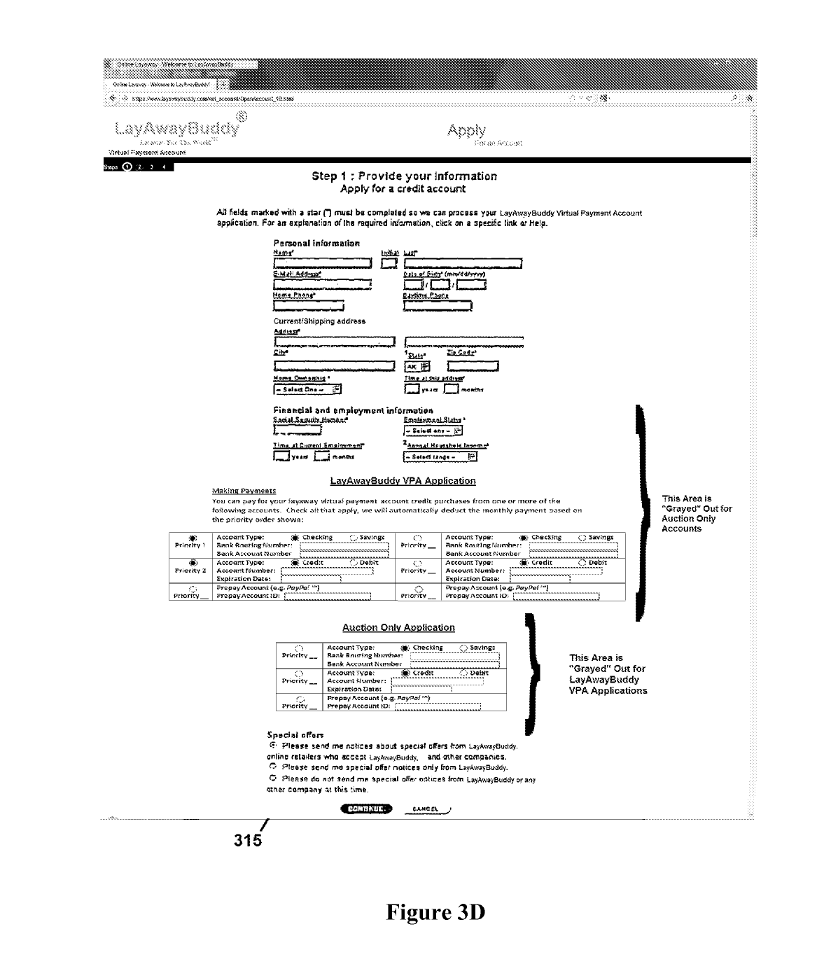

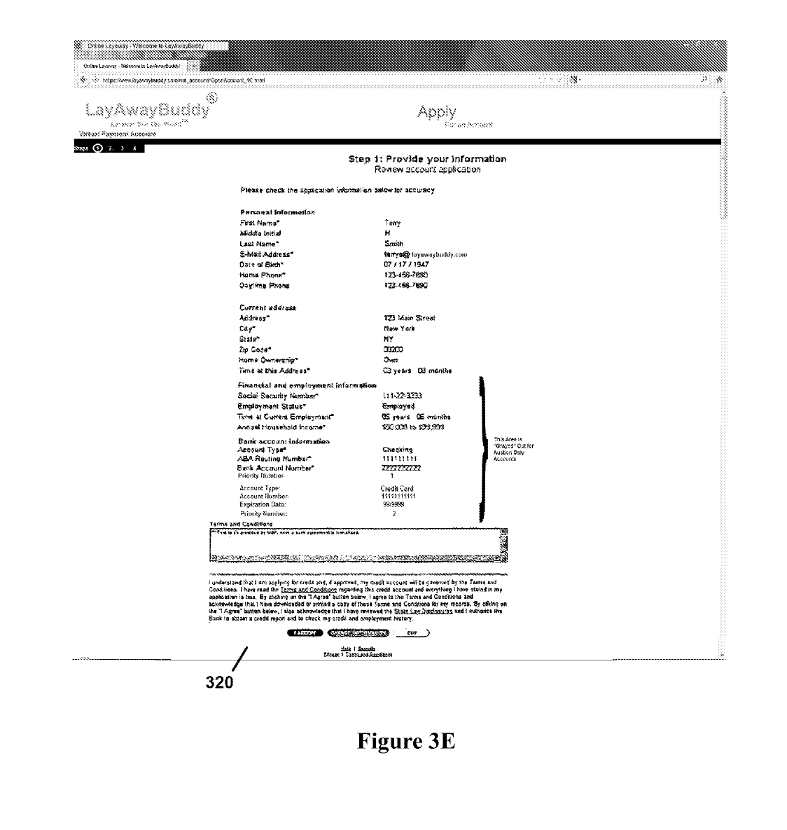

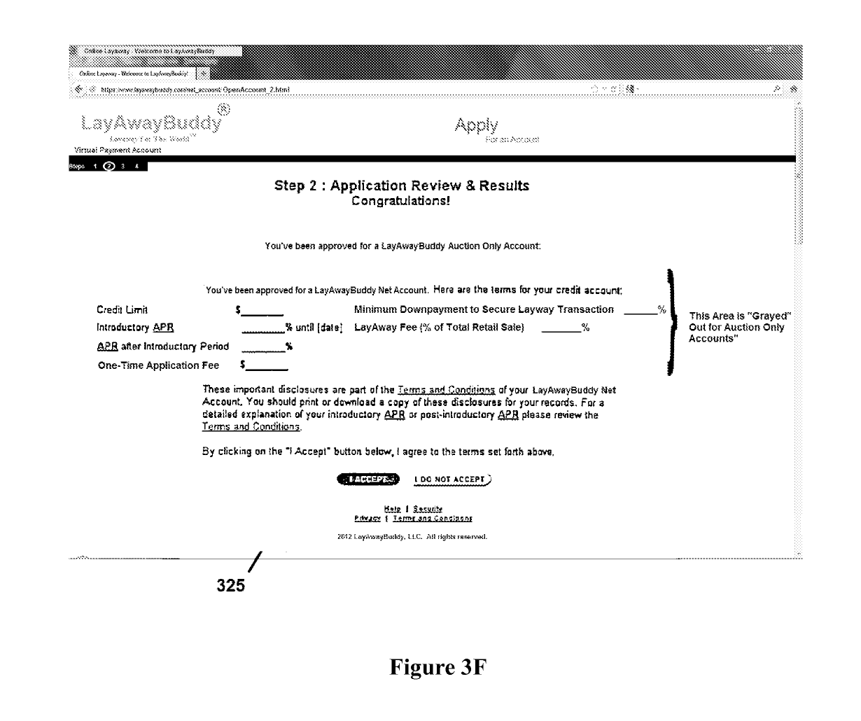

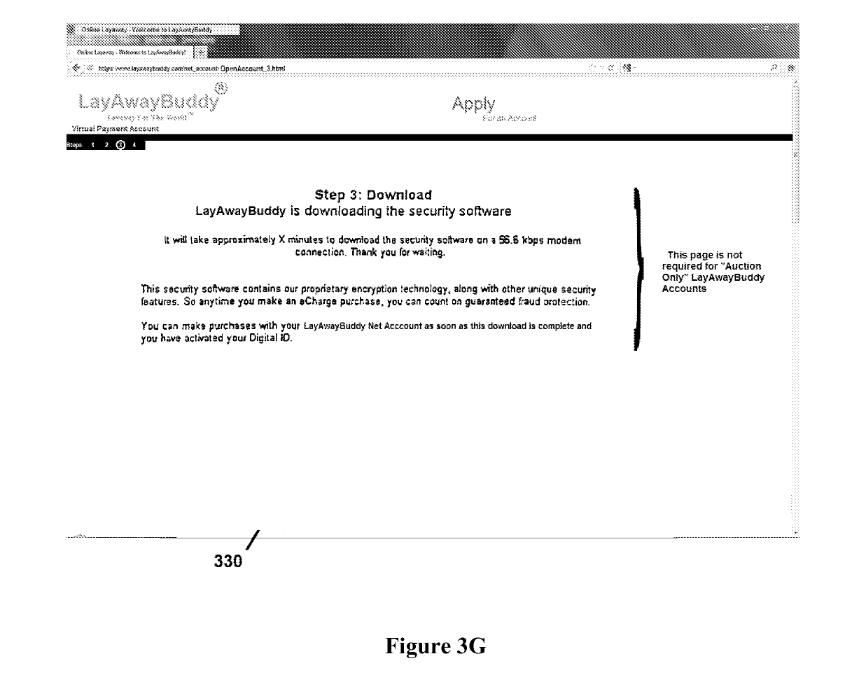

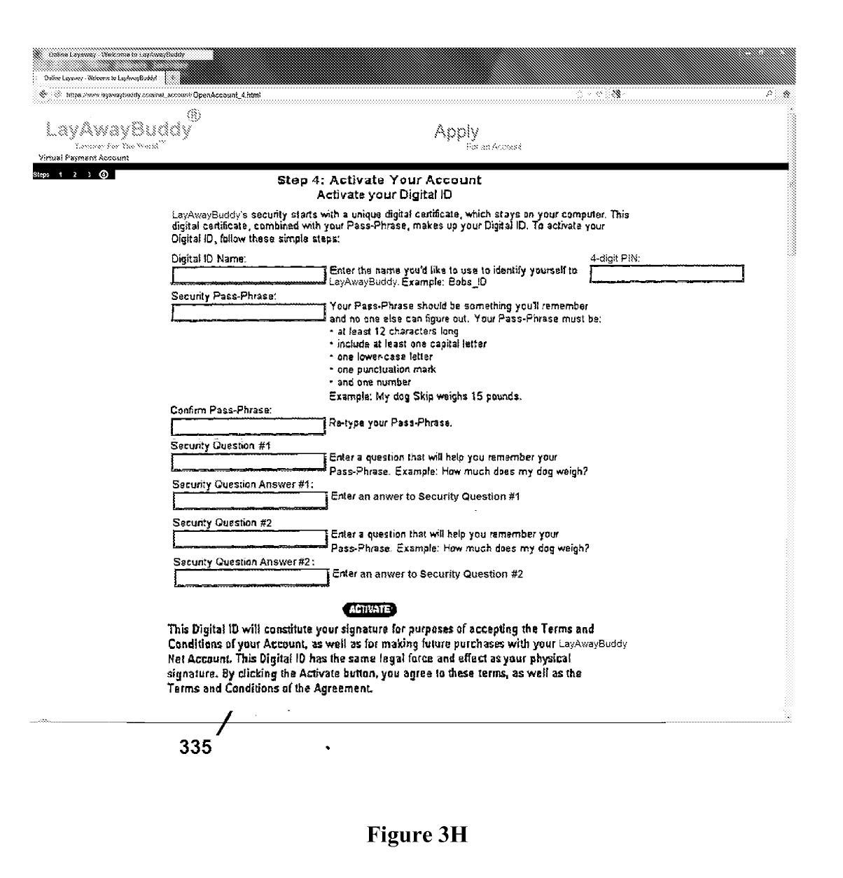

FIGS. 3A-3H are exemplary Web pages provided to the buyer by the Web browser of the buyer internet connected device 101a-d in connection with applying for a virtual payment account as described above. Using the home web page 300 shown in FIG. 3A, the buyer selects the hyper link to start to the virtual payment account application. Using the web page 305 shown in FIG. 3B, the buyer selects the type of layaway account they desire to apply for, e.g., virtual payment account credit and auction or auction only account, and submits the information by clicking “continue.” Next, the web pages 310, 315 and 320 shown in FIGS. 3C-3E for the application form are displayed to the buyer via the web browser. In one actual embodiment of the present invention, the buyer fills out the application form with the appropriate application data on-line. Alternatively, the buyer can request the application on a printed form and submit the printed form via facsimile or regular mail, in which case a customer service representative will enter the information into the account database 106 of the credit processing server 107 via the Layaway Contract Management server 104. The application data includes information such as social security number and income that will be used to determine a credit limit for the buyer. Information entered by the buyer in the application form is also used for demographic purposes. For example, banner advertisements can be displayed via the web browser on the buyer internet connected device 101a-d and can be targeted to the buyer based on demographic information, such as the buyer's age and geographic location.

After the buyer completes the application form contained in the web pages, 310, 315 and 320 shown in FIGS. 3C-3E and the application is processed by the credit processing server 107, a web page 325 as shown in FIG. 3F is transferred to and displayed by the buyer internet connected device's web browser, which notifies the buyer of the results of the application process, i.e., account approval and details of his or her virtual payment account, including the account credit limit and the application fee, layaway fee and minimum down payment that will be paid to the LCM. Once the account approval is complete and the account accepted by the buyer, the Layaway Contract Management server 104 then transmits the buyer authenticator component (which, as described above, generates a public key encryption key pair) to the buyer's computer for installation of the Layaway Contract Management server 104 software as shown in FIG. 3G and web page 330 and requests payment of the one-time application fee from the buyer's financial institution. FIG. 3H shows an exemplary web page 335 that allows the buyer to activate their virtual payment account.

In one exemplary embodiment of the security transaction, once the account is activated all the buyer has to do is to enable all internet connected device 101a-d to use the virtual payment account to forma layaway contracts is access the home web page 300 shown in FIG. 3A using the web browser of the buyer's internet connected device 101a-d and sign-in or “log in” using their digital ID name and Pass-Phrase, i.e., “user name” and “password.” The Layaway Contract Management server 104 checks the devices authenticator component and if it does not exist then transmits the authenticator component (which, as described above, generates a public key encryption key pair) to the buyer's computer for installation of the Layaway Contract Management server 104 software as shown in FIG. 3G and web page 330.

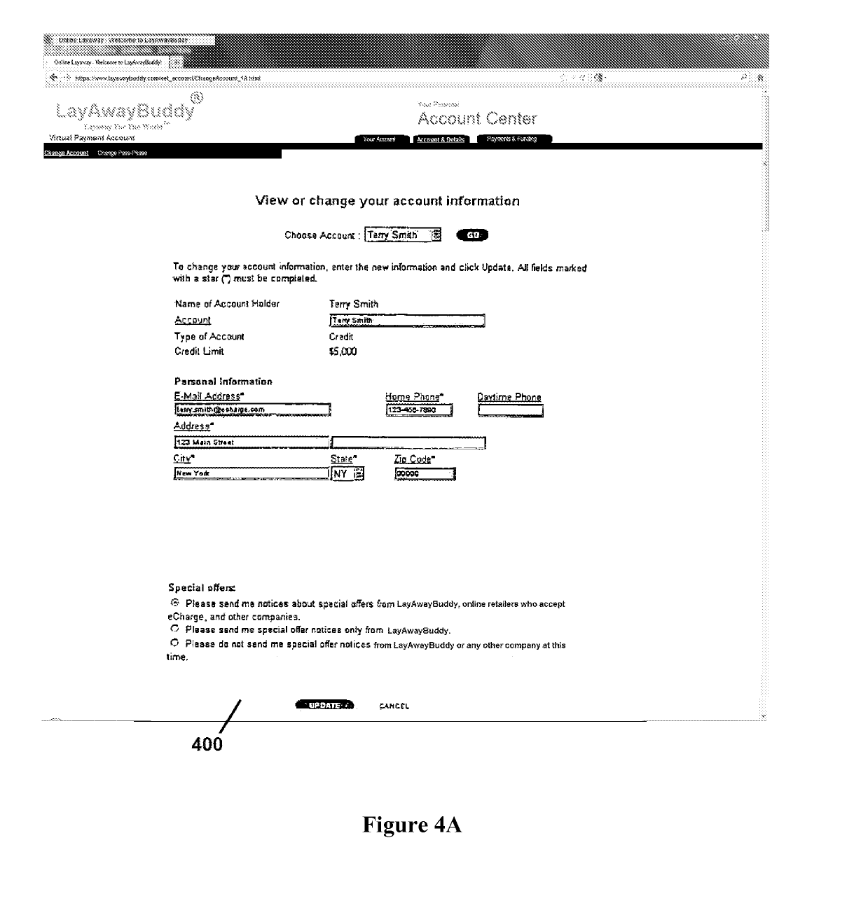

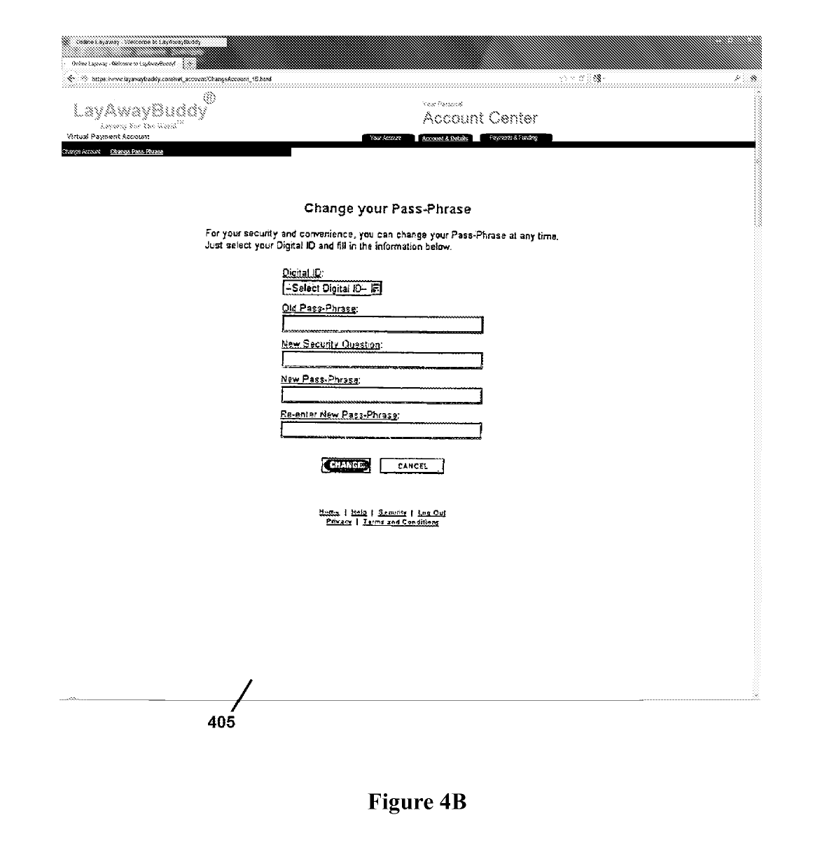

Once a virtual payment account has been approved and a credit limit set as described above, the account can be customized by the buyer. Account information is then stored in the account database 106 for access by the credit processing server 107. FIGS. 4A-4B illustrate an exemplary set of web pages downloaded from the Layaway Contract Management server 104 and displayed by the web browser of the buyer's internet connected device 101a-d for customizing the buyer's virtual payment account. FIGS. 4A-4B illustrate web pages 400 and 405 for main account customization. As shown in FIG. 4A, the buyer may customize his or her virtual payment account contact information and preferences. FIG. 4B illustrates that the main account holder is able to configure access controls for their account as shown in web page 405.

It will also be appreciated that a similar process is performed for an on-line or physical retailer seller to become an authorized or registered seller. In the embodiment, a seller can apply to become a participant by completing an application form on-line. It will be appreciated that when the seller application process is performed on-line, a web browser component is used to display web pages on the seller's computer display 102. The seller forms a contract with the provider of the LCM server 104. In one exemplary embodiment, this contract includes terms such as the billing period and the transaction fee that will be paid to the LCM provider. A seller selling different types of data can have different accounts. For example, a book store may have a general account and one or more restricted accounts, for example, the restricted accounts may prohibit sales of adult products to minors. This can be in the form of a rating system (e.g., G, PG, PG13, NC17, R, etc.). In a similar manner to the buyer application process, once a seller has been approved and the seller account customized, a digital certificate is installed on the seller's computer 102 to identify the seller as a registered seller in the virtual payment system. The digital certificate is used in combination with a secret key generated by the seller server 102 and a public key generated by the seller server 102 and sent to the LCM server 104 to encrypt/decrypt messages for greater security.

It will be appreciated, as described earlier, that a seller can apply for a “buyer” account. In other words, a seller can purchase products as the owner of a virtual payment account.

### Digital Security

As will be described in more detail below, once the virtual payment account has been authorized 215 and customized, a digital certificate is transferred by the LCM server 104 and installed 216 on the buyer computer 101a-d. The digital certificate is then used in subsequent transactions as a unique credential to identify the buyer as a registered holder of a virtual payment account. In an actual embodiment of the present invention, a buyer or seller is identified as a registered user of the virtual payment system by the LCM server 104 verifying the commerce gateway's digital signature on the digital certificate associated with the buyer's virtual payment account

It will be appreciated that several levels of security, can be imposed on on-line transactions. Moving from the lowest level to the highest level, there can be: (1) no security restrictions imposed; (2) minimal security, such as account name and password verification; (3) intermediate security, such as a digital certificate or secret key; (4) high security, such as a transaction signed with a digital signature using the buyer's secret key; or (5) maximum security, such as a digital signature and additional access controls, such as an account number, a last purchase verification, smart cards, secure tokens or some combination thereof. As will be described later, in the actual embodiment of the virtual payment system described herein, the term “digital certificate” is used to describe the authorization used; however, it will be appreciated that a higher level of security such as a digital signature, or a digital signature with additional access controls may be desired in order to ensure the highest level of security for all parties involved (i.e., the buyer, the seller, the layaway account access gateway, and the credit processing server) in virtual payment account transactions.

In one exemplary embodiment of the security transaction, the seller server 102 digitally signs a purchase offer with a certificate issued by the LCM server 104 and sends it to the buyer computer 101a-d; the buyer computer 101a-d digitally signs the purchase offer with a certificate issued by the LCM server 104 and sends it back to the seller server 102; the seller server 102 then forwards the doubly signed purchase offer to the LCM server 104; the LCM server 104 verifies both signatures and if they are both valid and the transaction is permissible then signs the doubly signed offer and returns the resulting triply signed purchase offer to the seller server 102; the seller server verifies the LCM server's 104 signature, and if it is valid, then the purchase transaction is complete. In the aforementioned example, the seller server 102 may notify the buyer computer 101a-d or they may not.

### Purchasing Products from a Registered On-Line Retailer

Once a buyer has created and customized his or her virtual payment account, he or she can immediately order products via the Internet if he or she was granted credit during the account application process. If, however, the buyer's virtual payment account is only a prepaid account, approval of the transaction will only be granted when the prepaid account is sufficiently funded to cover the initial minimum down payment (e.g., ten percent of retail value plus shipping) by which the layaway transaction is made secure. After which, the virtual payment prepaid only account must remain sufficiently funded to cover the automatic monthly payment withdrawals on the remaining retail balance plus layaway and additional shipping fees or risk the virtual payment account going into default. It will be appreciated that a registered on-line seller can be an auction web site, in which a buyer uses his or her virtual payment account to pay for the goods and/or content purchased from the auction web site.

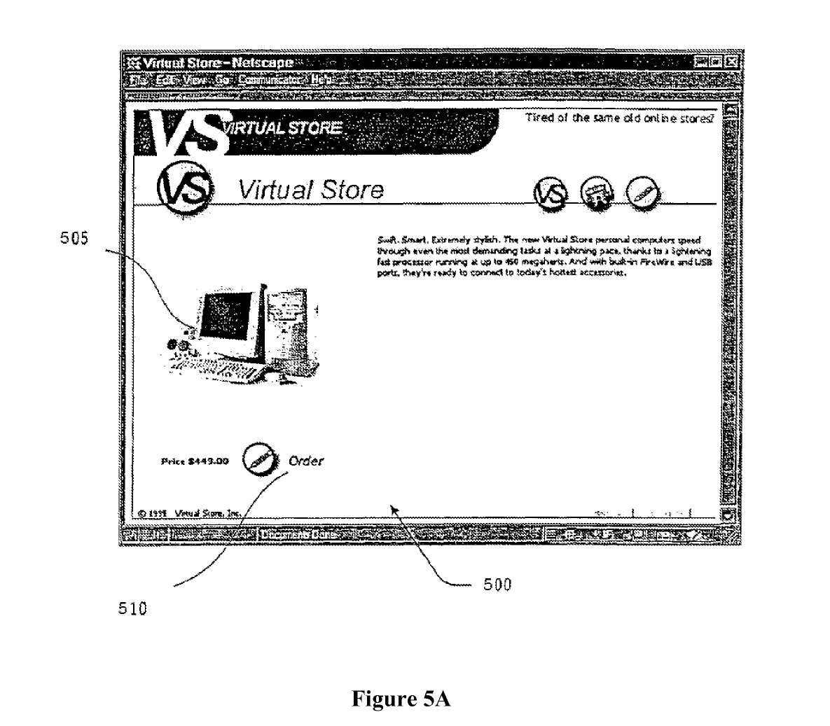

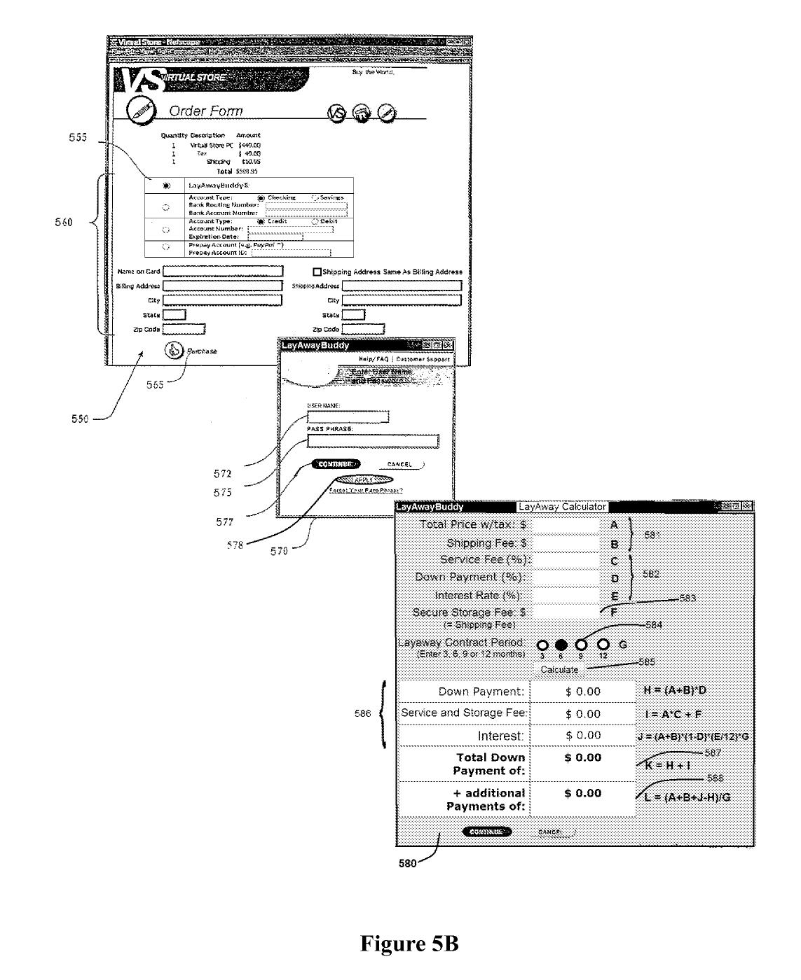

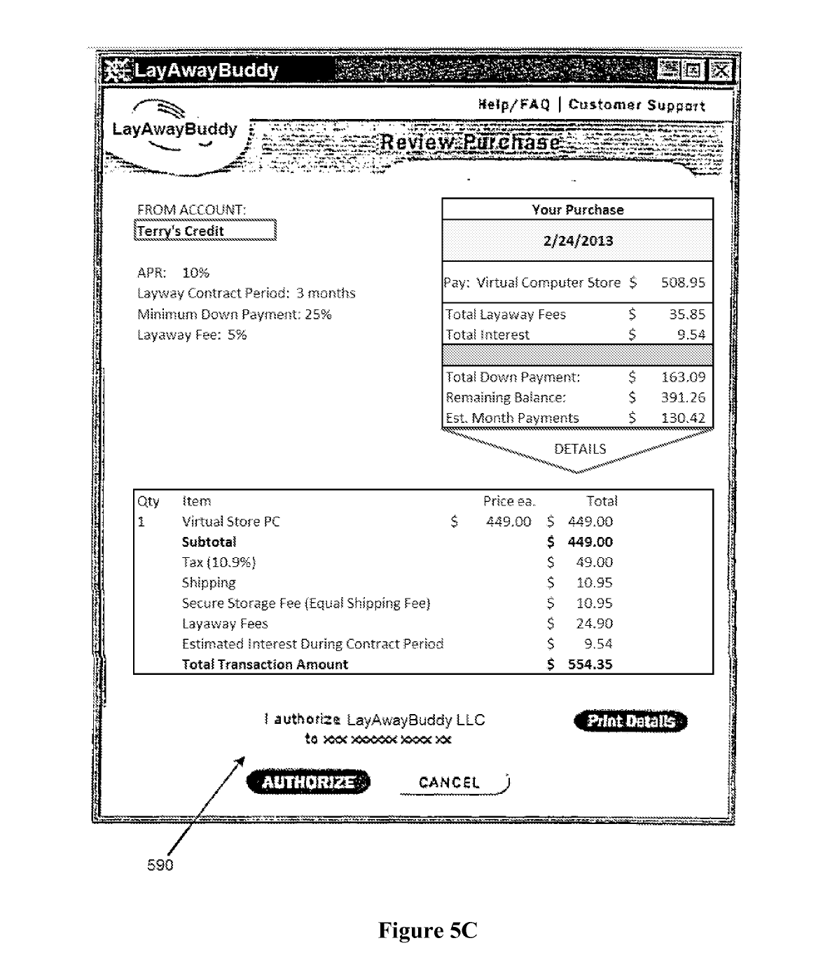

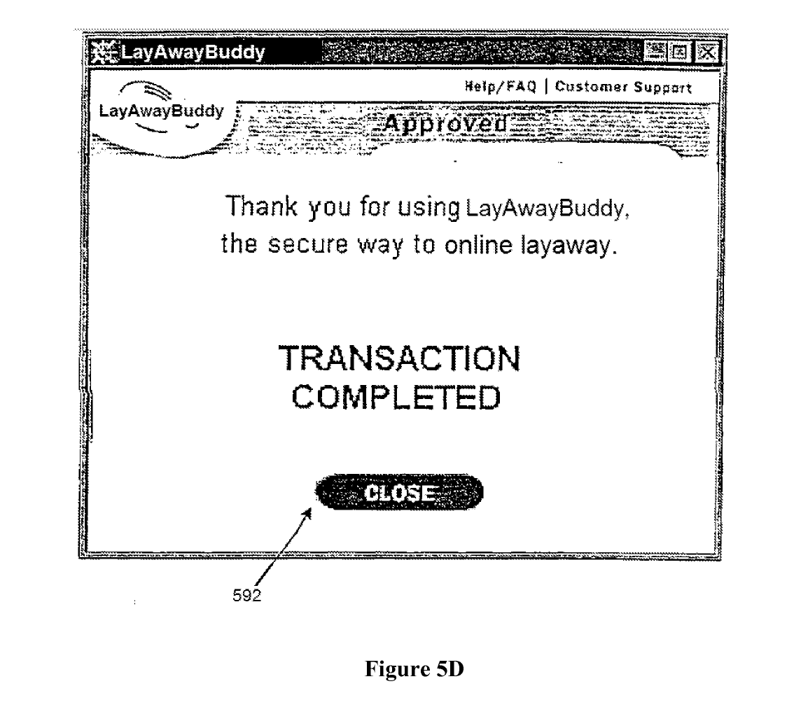

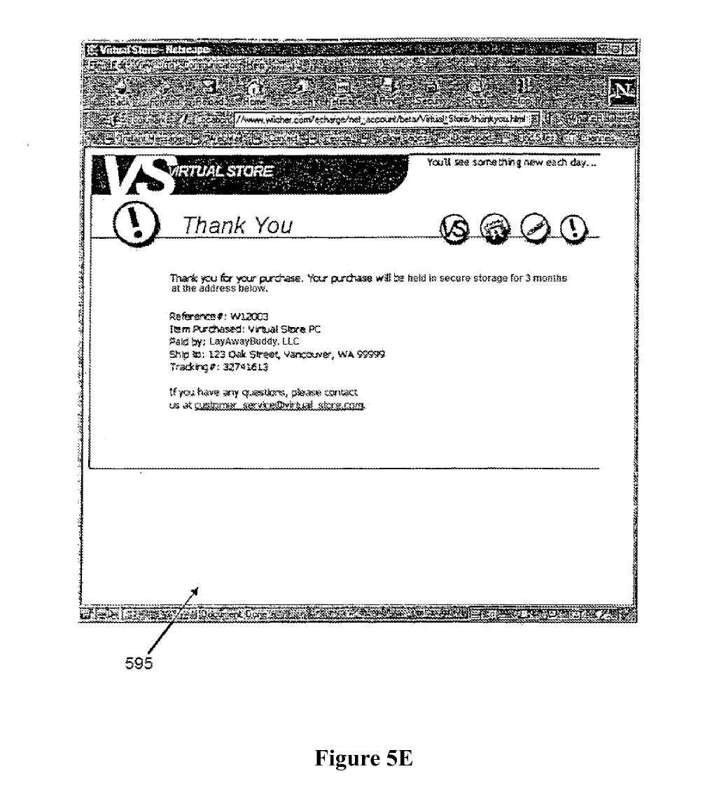

In one actual embodiment of the present invention depicted in FIGS. 5A-5E, the buyer may “surf the web” and visit a registered seller's web site, such as “Virtual Store,” 500 using the web browser on the buyer computer 101a-d. Once the buyer visits a registered seller's web site, the buyer may order and pay for products offered from that web site using his or her virtual payment account. More specifically, a buyer using buyer computer 101a-d and Web browser on the buyer computer 101a-d may retrieve the web page 500 shown in FIG. 5A from the registered on-line seller web site fictitiously known as “Virtual Store.” The buyer makes a selection of a particular product 505 by manipulating a graphics cursor with a pointing device, such as a mouse above the selection 510 and “single-clicking.” It will be appreciated that other pages, for example, a query page in which the buyer requests products by a keyword, may be displayed. It will also be appreciated that the web page 500 shown in FIG. 5A is a simplified example. It is common for a seller site to allow a buyer to select multiple products and place them in a “shopping cart.” The buyer can then view the items in the cart and, if desired, remove items from the cart. Once the buyer has selected the desired items for purchase, the buyer indicates a desire to purchase the selected items, for example, by clicking an “OK” or a “Buy” button. In the simplified example shown in FIG. 5A, the buyer selects an item, such as the Virtual Store Personal Computer 505 and presses the “Order” button 510 to initiate the purchase transaction.

After initiating the purchase transaction or “Checking Out,” the seller server 102 provides the web browser of the buyer's computer 101a-d with the web page 550 shown in FIG. 5B which requests the buyer's billing and shipping information 560, such as a street address, from the buyer. Additionally the web page 550 includes various payment options, i.e., major credit cards, such as VISA® or MASTERCARD®, Prepay option, e.g., PayPal®, debit card such as VISA®, or checking or savings account with electronic transmission of credit and/or account information. In accordance with the present invention, a layaway virtual payment account option is also displayed as a payment option for registered sellers. After entering the buyer's billing, shipping, and applicable payment information for the type of payment option selected 560 and selecting the layaway virtual payment option 555, the buyer can continue by clicking on the “Purchase” option 565. In an actual embodiment of the present invention the authenticator of the buyer's internet connected device 101a-d, displays a window 570 requesting the buyer to enter their digital ID or user name 572, along with an authenticating pass phrase or password 575 for the virtual layaway account. After entering the correct user name and password, the buyer clicks “Continue” 577 to proceed with the purchase. In response, the buyer's internet connected device 101a-d invokes the Layaway Calculator 580 shown in FIG. 5B. The retail sale amount, taxes, and shipping cost 550 as shown in FIG. 5B are “auto” entered into the layaway calculator fields 581. The information from web page 325 as shown in FIG. 3F, i.e., the annual interest rate, layaway fee and minimum down payment 582 that will be paid to the LCM 104 are “auto” entered in fields of FIG. 5B. The layaway calculator 580 auto-calculates the secure storage fee 583 as equal to the shipping fee or a minimum storage fee, whichever is greater. The buyer then enters the number of months of the layaway contract period 584. After entering the number of months of the layaway contract period 584, the buyer clicks “Calculate” 585 to calculate the initial down payment, layaway and storage fees, and interest fees 586, followed by the total initial down payment 587 and additional monthly payments 588 per the layaway contract period 584 and then proceed with the purchase by clicking “Continue.” In response, the seller server 102 configures the total cost of the order, from the layaway calculator 580, and the buyer is presented with a confirmation screen 590 as shown in FIG. 5C. After authorizing the purchase, the buyer may be presented with a payment confirmation screen 592 as shown in FIG. 5D. Additionally, the buyer may be presented with an order confirmation screen 595 as shown in FIG. 5E indicating the shipping location for the secure storage facility where the layaway purchase will be held for the duration of the layaway transaction period. At this time, the initial down payment is automatically deducted from the buyer's specified bank, debit, or credit account 109 110 and paid to the LCM financial institution 111 112 whereby the layaway transaction is secured.

For non-registered buyers, the buyer clicks “Apply” 578 to open a new web page or web tab and automatically link to the process web page 305 and proceed with the layaway virtually account application process shown in FIG. 3B. After entering the correct user name and password, the buyer clicks “Continue” 577 to proceed with the purchase.

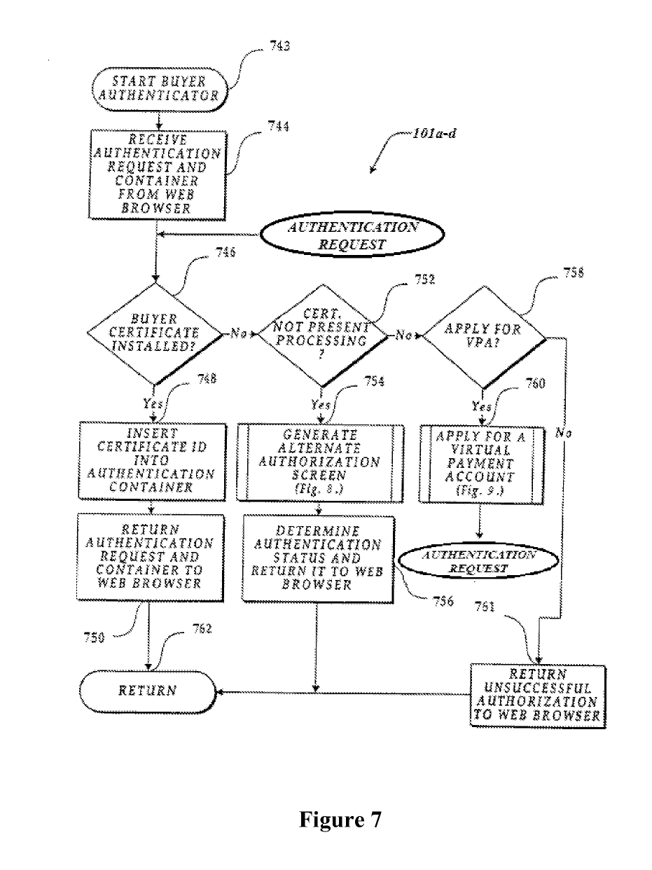

FIG. 6 illustrates the logic implemented by the web browser installed on the buyer computer 101a-d when the virtual payment account layaway option 555 is selected for a registered buyer. The logic begins in a block 620 and proceeds to a block 622 where a secure connection between the buyer computer 101a-d and LCM server 104 is established. In an actual embodiment of the present invention, the Secure Socket Layer (SSL) protocol is used for establishing a secure connection. SSL uses public key encryption incorporated into a web browser, such as INTERNET EXPLORER® web browser and INTERNET EXPLORER's commerce servers, to secure the information being transferred over the Internet. The logic then proceeds to a block 624 where a buyer authenticator component on the buyer computer 101a-d is executed. It will be appreciated that the buyer authenticator component, web browser of the buyer computer, and buyer computer 101a-d are all virtually one in the same. The buyer authenticator function of the buyer computer 101a-d is shown in more detail in FIG. 7 and described next.

The buyer authenticator 101a-d determines whether a buyer is a registered holder of a virtual payment layaway account or, put another way, a registered participant in the closed layaway virtual payment system of the present invention. The logic of FIG. 7 begins in a block 743 and proceeds to a block 744 where an authentication request and container are received from the web browser 101a-d. The container includes: transaction information, such as purchase detail; identification of the parties, such as a buyer identification which identifies the buyer, e.g., the digital certificate previously issued to the buyer when he or she created the virtual payment account as described above; and a seller identification, e.g., the digital certificate issued to the seller upon creation of a seller account; and context, such as transaction date and time. It will be appreciated that the container is initially empty, and data is then added to the container by various components. As stated earlier, embodiments of the invention implement the buyer authenticator in the web browser 101a-d. In one actual embodiment, the buyer authenticator is an applet operating from within the web browser 101a-d.

Next, in decision block 746, a test is made to determine if a digital certificate is installed on the buyer computer 101a-d. The digital certificate may be stored securely in the memory of any of the buyer internet connected devices 101a-d and are returned to the web browser 101a-d in blocks 748 and 750. In an actual embodiment of a present invention, a public key generated by the buyer's computer 101a-d and signed by the LCM server 104 (thereby forming a digital certificate) is also inserted into the container. The secret key is never transmitted anywhere in the virtual payment system of the present invention. The combination of the secret key and the digital certificate provides a heightened level of security to the buyer authentication process. A digital signature is generally a document that has been encrypted by the secret key of a public key pair. Only the public key of the same key pair will be able to decrypt the document to its original form. This is particularly useful in demonstrating that only the holder of the secret key is able to sign (encrypt) the document. In practical terms, signing a large document using public key cryptography can be very time consuming. Almost equally effective is creating a cryptographic message digest of the document and then encrypting the digest with the secret key. Therefore those of ordinary skill in the art will appreciate that anyone knowing the corresponding public key and the digest algorithm will be able to verify that the message was not altered and that it originated from the holder of the corresponding secret key. It will be appreciated that the digital certificate as used herein refers to an authentication identifier that is recognized by the provider of the virtual payment account that adheres to the provider's non-repudiation purchase policies.

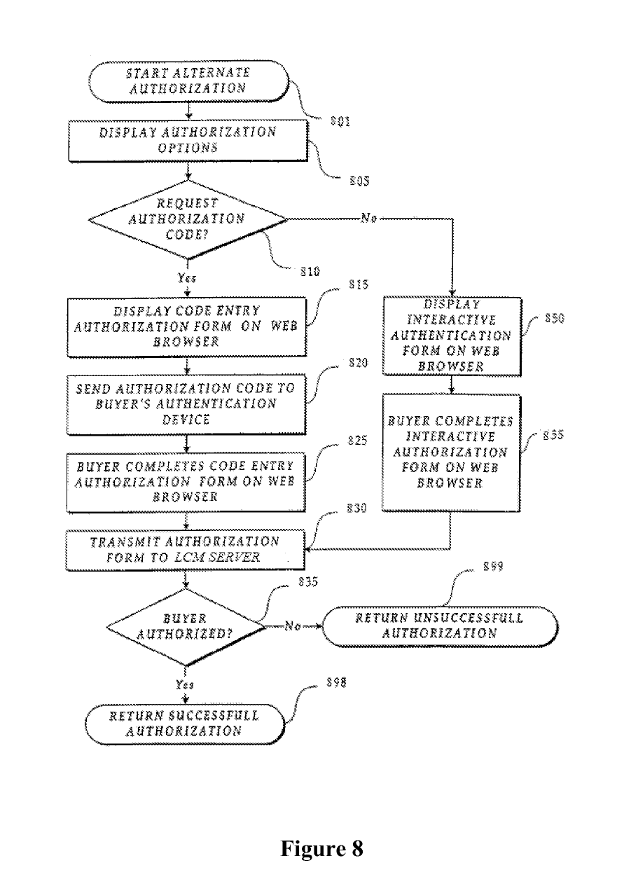

If, however, in decision block 746 it is determined that a digital certificate is not installed on the buyer computer 101a-d, the logic proceeds to a decision block 752 where a test is made to determine if “certificate not present” processing should be performed. Certificate not present processing allows a buyer to manually enter identification information when a digital certificate is not present. The identification information can include information such as an e-mail address, a password and personal information, for example, a mortgage payment amount. If the result of decision block 752 is positive, the logic proceeds to an alternate authentication in block 754. The alternate authentication is shown in more detail in FIG. 8 and described next.

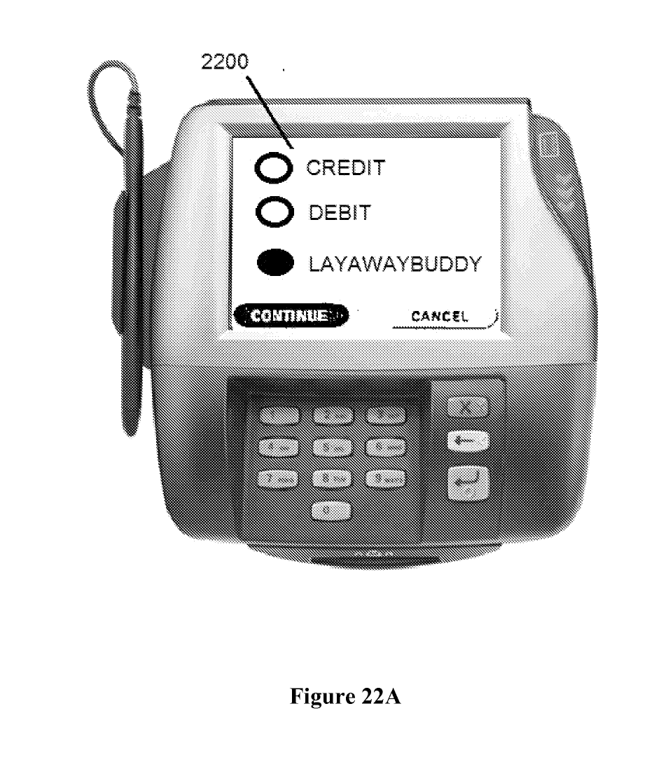

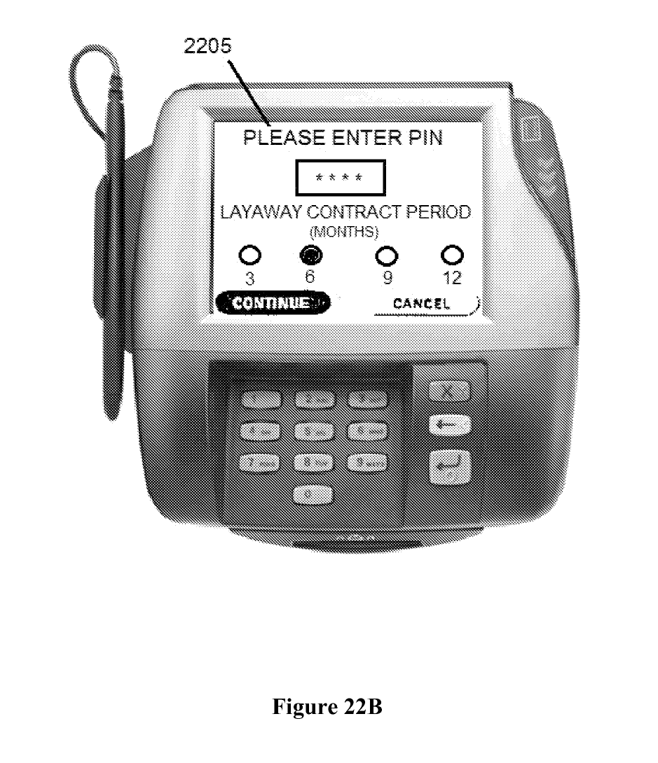

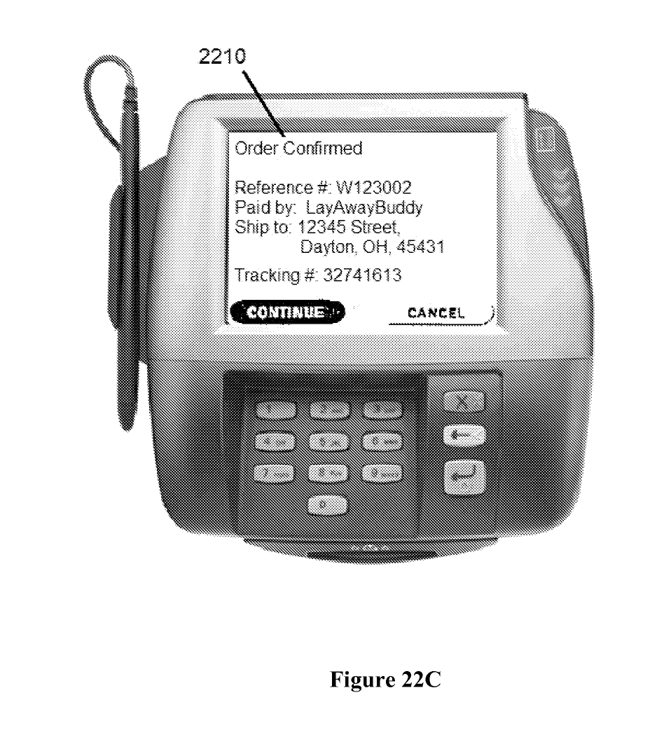

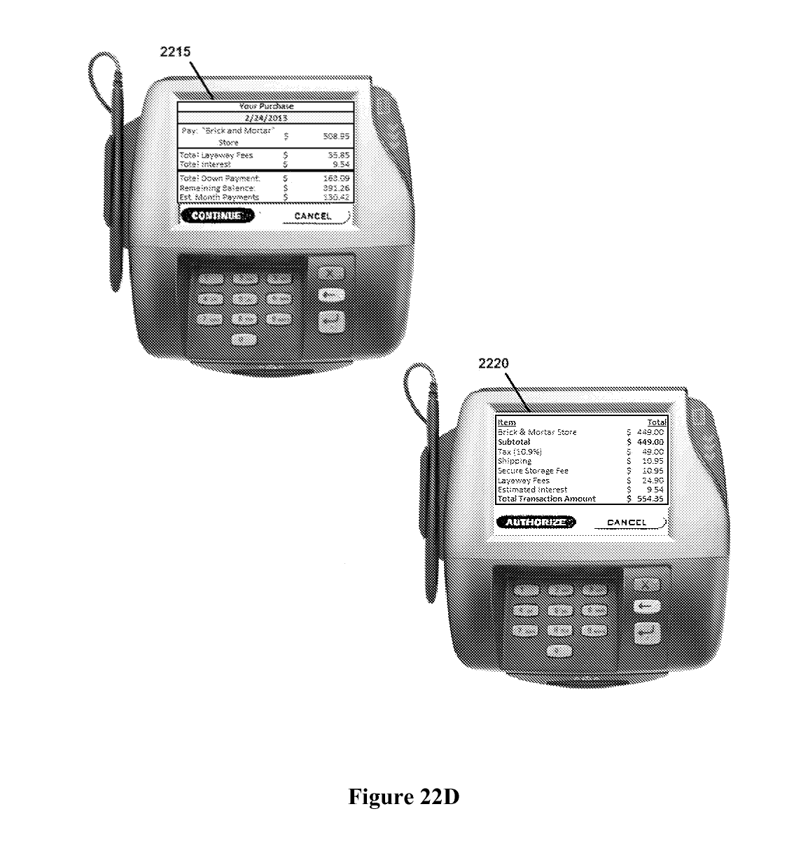

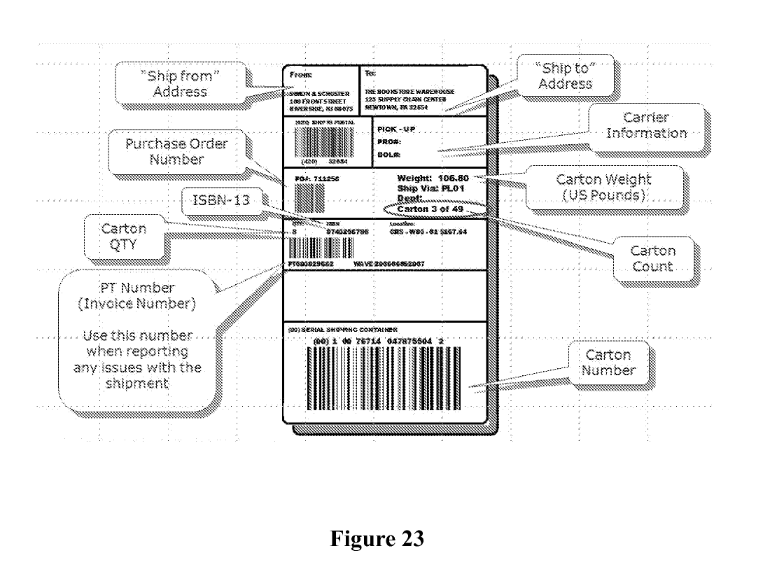

The logic of FIG. 8 begins at a block 801 and proceeds to block 805 where the authorization options are displayed to the buyer. Next, it is determined in a block 810 if the buyer requested an authorization code as the alternate authorization mechanism. If the buyer did choose to receive an authorization code, then the web browser 101a-d on the buyer computer is sent an authorization code entry form in a block 815 and the authorization code is sent to an authentication device in a block 820. Exemplary authentication devices 2200 or 2300 are shown in FIGS. 22 and 23 respectively. After receiving the authorization code, the buyer enters the code in the authorization code entry form in a block 825.

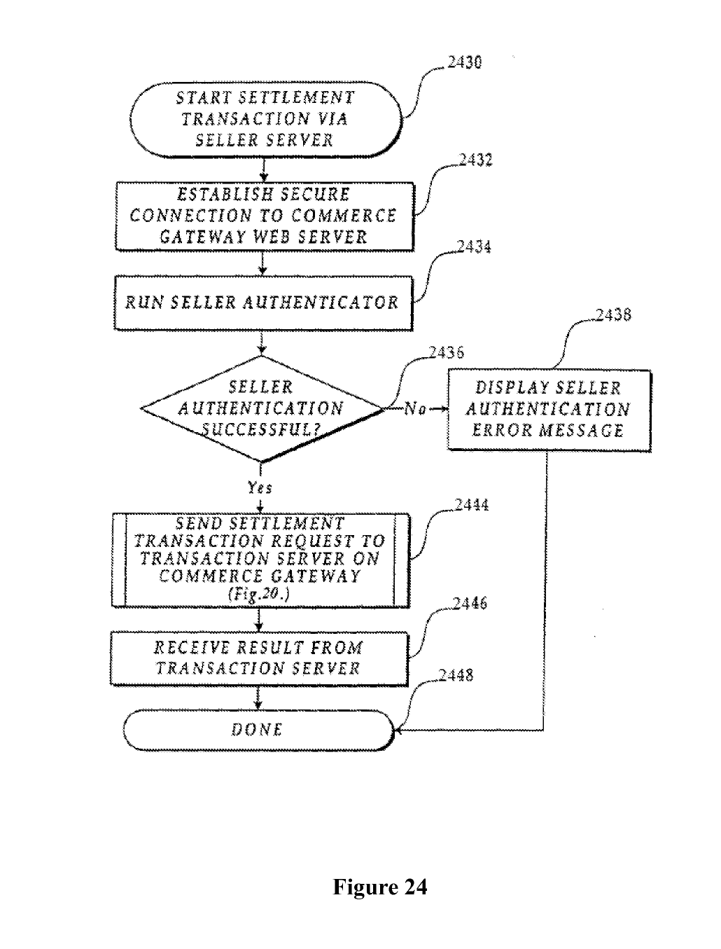

If however at block 805 the buyer decides not to request an authorization code, then from block 810 the logic flows to a block 850 where an interactive authentication web form 2400 is sent to the web browser on the buyer's computer 101a-d. An exemplary interactive authentication web form 2400 is shown in FIG. 24. Next in a block 855 the buyer completes the interactive authentication web form 2400.

Next, the completed authorization entry form from block 825 or 855 is transmitted to the LCM server 104 in a block 830. The logic then proceeds to a block 835 where it is determined whether the authentication was successful. If the authentication was successful the logic ends at a block 898 returning a successful authentication. If the authentication was unsuccessful the logic ends at a block 899 returning an unsuccessful authentication.

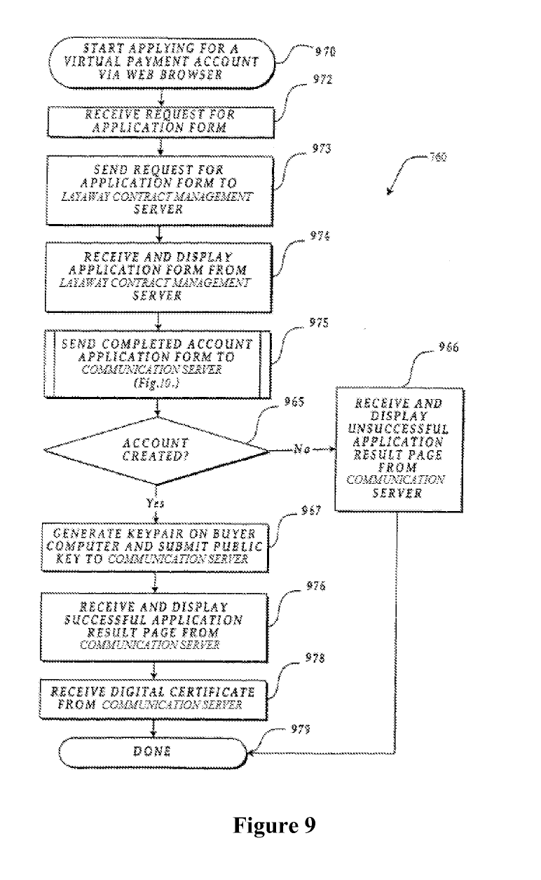

Returning to FIG. 7 the logic then moves to a block 756 where the information from the alternate authentication process is passed back through the buyer authenticator 101a-d and the logic ends at block 762. If there is no digital certificate installed (“No” in decision block 746) and certificate not present processing is not going to be performed, for example by a user selecting “cancel” 2410 in the certificate not present authorization web page 2400 shown in FIG. 24 (or “No” in decision block 752), the buyer likely does not have a virtual payment account. Accordingly, the logic of FIG. 7 proceeds to a decision block 758 where a test is made to determine if the buyer wishes to apply for a virtual layaway payment account. If the buyer wishes to apply for a virtual payment account, the logic proceeds to a block 760, in which the buyer is allowed to apply for a virtual payment account as shown in FIG. 9 and described next. Otherwise, the buyer authenticator 101a-d returns an unsuccessful authorization message to the web browser 101a-d in a block 761 and the logic ends in block 762.

FIG. 9 illustrates the logic implemented by the web browser 101a-d when a buyer applies for a virtual payment account. It will be appreciated that applying for a virtual payment account can be invoked by a buyer requesting an account directly from the LCM server 104 or by a buyer who is not registered attempting to order a product from a registered seller. In either case, the logic for applying for a virtual payment account via a web browser 101a-d begins in a block 970 and proceeds to a block 972 where a request for an application form is received by the web browser 101a-d. Next in a block 973, the request for an application form is sent to the web server component of the LCM server 104, the requested application form is then received from the web server component of the LCM server 104 and displayed in the buyer's web browser 101a-d in a block 974.

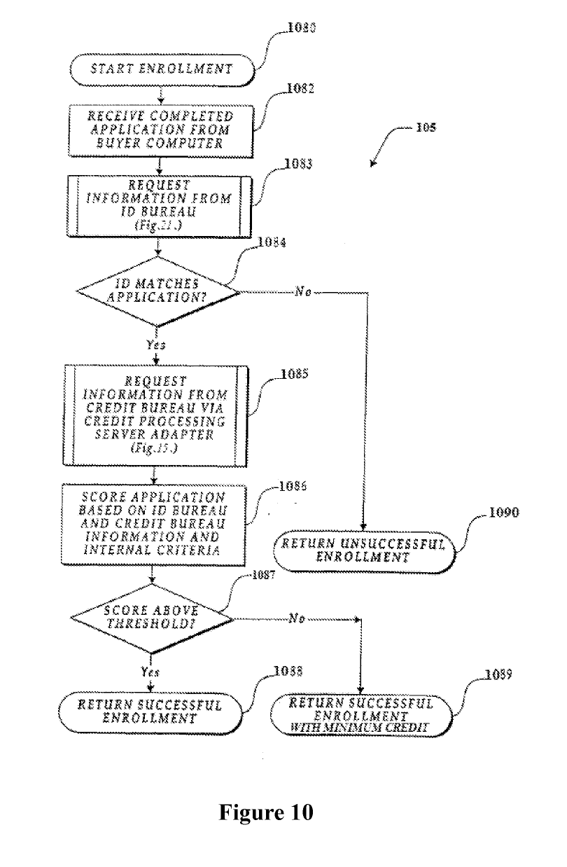

Next, in a block 975, the completed account application form is sent to the LCM server 104 and processed by a communication server component 105 as shown in FIG. 10, and described next. In another embodiment, the account application is sent to the transaction component of the LCM server 104 that handles financial transactions and also handles non-financial transactions, such as enrollment.

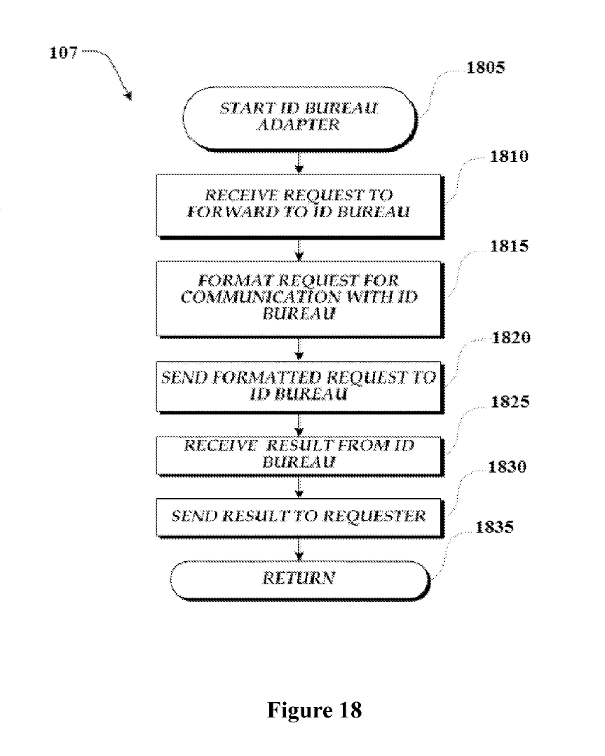

The logic of the communication server 105 shown in FIG. 10 begins in a block 1080 and proceeds to a block 1082 where a completed application form is received from the web browser 101a-d. Next, in a block 1083 identity information, such as name, employer, current residence, etc., is requested from an identity bureau 107 via the identity bureau adapter whose logic is shown in FIG. 18 and described next.

Accordingly, the logic of FIG. 18 begins in a block 1805 and proceeds to a block 1810 where the identity request is received. The request is then formatted to be compatible with the particular identity bureau in a block 1815. Next, the logic proceeds to a block 1820 where the formatted request is then sent to identity bureau 107. The result of the request is received from the identity bureau 107 in a block 1825. Next, in a block 2130, the result is then returned to requester. The logic of FIG. 18 then ends in a block 1835.

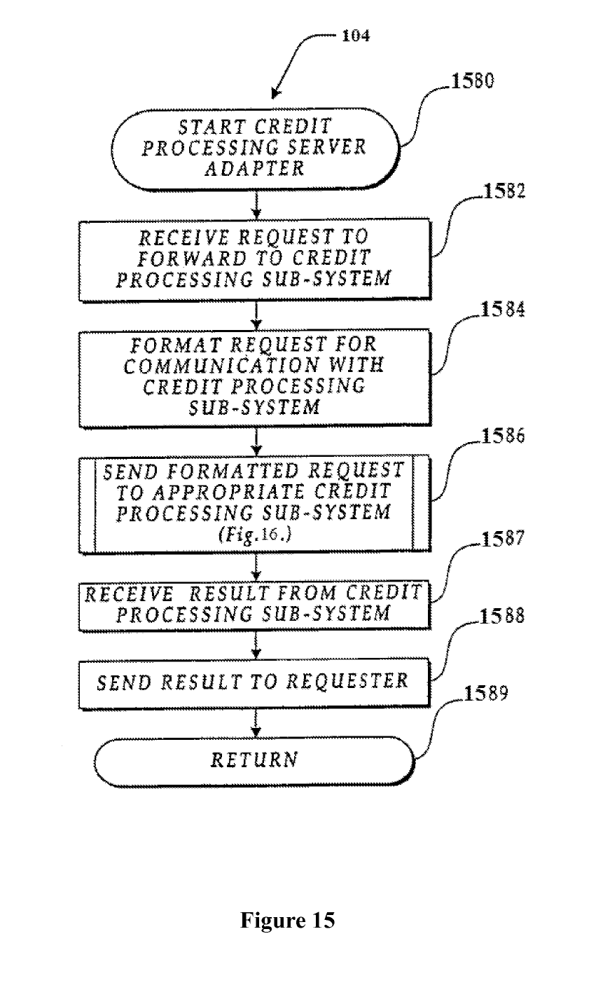

Returning to FIG. 10, if in a block 1084, which in this case is the communication server 105, it is determined that the identity information received from the identity bureau 107 via the identity bureau adapter corresponds to the information in the application received in block 1082, then processing continues to a block 1085 where the communication server 105 requests credit information, such as income, length of time with current employer, length of time at current residence, etc., from a credit bureau 108 via the credit processing server adapter as shown in FIG. 15 and described later with reference to a purchase authorization request.

Upon receipt of the credit information, the logic proceeds to a block 1086 where the application is scored based on the identity bureau 107 information and credit bureau 108 information in combination with internal criteria. The internal criteria provide a score for the various pieces of credit information. For example, incomes will be broken down into ranges, with a point value assigned to each range. Similarly, point values will be assigned based on the time the applicant has lived at his or her current residence, etc. The points for each piece of credit information are combined to determine a score for the applicant. The score equates to the credit worthiness of the buyer and is used to determine if the applicant will receive a credit account, and if so, to establish a credit limit for the applicant, i.e., buyer. Next, if the score is above a threshold logic ends with a successful enrollment result and credit limit commensurate to the credit score and returned to the web browser 101a-d in a block 1088. However, if the score is below a certain threshold logic ends with a successful enrollment result and a minimum credit limit commensurate to the credit score and returned to the web browser 101a-d in a block 1089. If the identity information provided by the identity bureaus 107 does not correspond to that of the buyer's application, then an unsuccessful result is returned in a block 1090. Processing then returns to FIG. 9.

In FIG. 9, once a response is received from the communication server 105 a block 965 examines whether an account was created. If it was, then a request is sent to the buyer computer 101a-d to generate a public key encryption pair in block 967 and to submit the public key to the communication server 105 on the LCM server 104. The communication server 105 then signs the public key to create a digital certificate and returns a successful enrollment web page 325, as shown in FIG. 3F, which is received in a block 976 along with the digital certificate in a block 978. If at block 965 it was determined that an account was not created, then an unsuccessful application web page is displayed (not shown) at a block 966. In the case of applying for a virtual payment account, the result page 325 provides details of the new account for the buyer or contains a message informing the buyer that there was an error creating the account. The logic of FIG. 9 of applying for a virtual payment account then ends in a block 979 and processing returns to FIG. 7.

Referring again to FIG. 7, after the buyer has applied for a virtual payment account, the logic returns to decision block 746 where the test to determine if a digital certificate is installed on the buyer computer 101a-d is repeated. Depending on the results of decision block 746, either blocks 748-750 or blocks 752-756 are repeated for the recent applicant of a virtual payment account. The logic then ends in a block 762.

While the logic of authenticating a buyer as shown in FIG. 7 and described herein uses a digital certificate as the primary means for authenticating a buyer, it will be appreciated that other methods are possible. For example, a lesser level of security could be employed, whereby a user could be required to enter identifying information, such as the information entered in alternate authentication shown in FIG. 8. Alternatively, a greater degree of security could be employed whereby a digital certificate is required, and “certificate not present” processing is not allowed or, an even greater level of security could be used requiring a digital signature and other verifying information from the buyer.

Returning to FIG. 6, after buyer authentication is completed in block 624, the logic proceeds to a decision block 626, where a test is made to determine if the buyer authentication was successful. If not, the logic proceeds to a block 627 where an error message is displayed on the buyer computer 101a-d by the web browser 101a-d notifying the buyer of the failed authentication. The logic of FIG. 6 ends in a block 642.

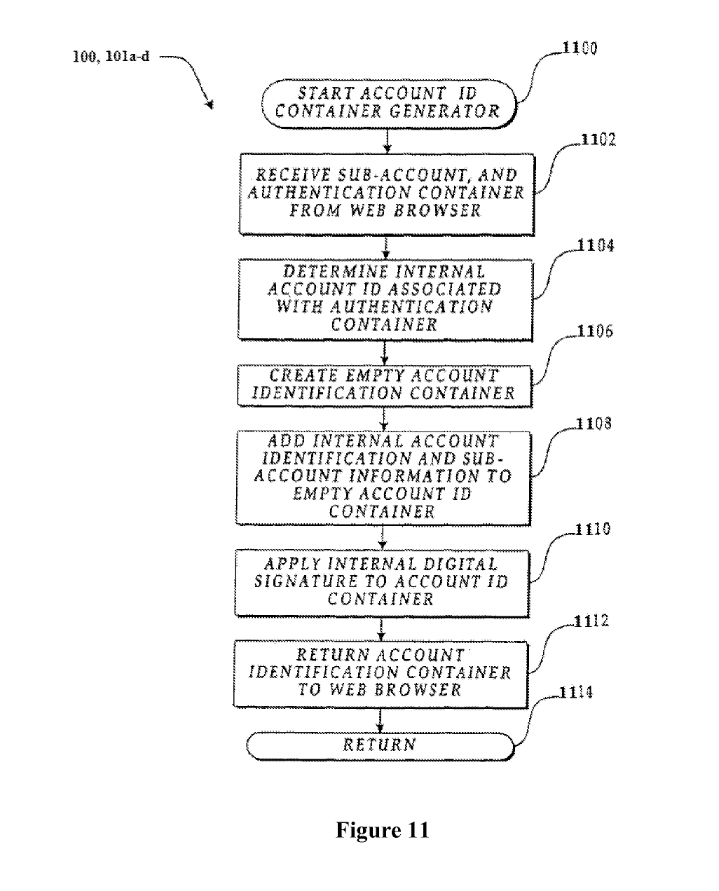

However, if the buyer was successfully authenticated, the logic proceeds to a block 628 where a virtual payment account selection web page 570 as shown in FIG. 5B is displayed. Included in the requested information of the virtual payment account selection web page 570 is an identification of the applicable account to which the purchase should be applied. Next, in a block 630, account and/or password information (used to unlock the buyer's digital certificate) are obtained from the buyer from the information entered in the virtual payment account selection web page 570 of FIG. 5B. When the buyer indicates that the information has been entered by selecting “Continue” 577, the logic of FIG. 6 then proceeds to a block 632 where the account and authentication container are sent to the LCM server 104 and processed by the account identification container generator from the web browser of the internet connected devices 101a-d. The process is shown in FIG. 11 and described next.

The logic of FIG. 11 begins in a block 1100 and proceeds to a block 1102 where the account and authentication container are received from web browser 101a-d of the buyer computer 101a-d. The logic then proceeds to a block 1104 where an internal account identification associated with authentication container is determined. An empty account identification container is then created in a block 1106. Next, in a block 1108, internal account identification and account information is added to the empty account identification container. The logic then proceeds to a block 1110 where an internal digital signature is applied to the account identification container. For example, message digest logic can be used by applying an algorithm that takes a variable length message and produces a fixed length digest as output using a one-way hashing algorithm that establishes the message as cryptographically secure. Finally, the account identification container is returned to the web browser 101a-d in a block 1112. The logic of FIG. 11 then ends at a block 1114, and processing returns to FIG. 6.

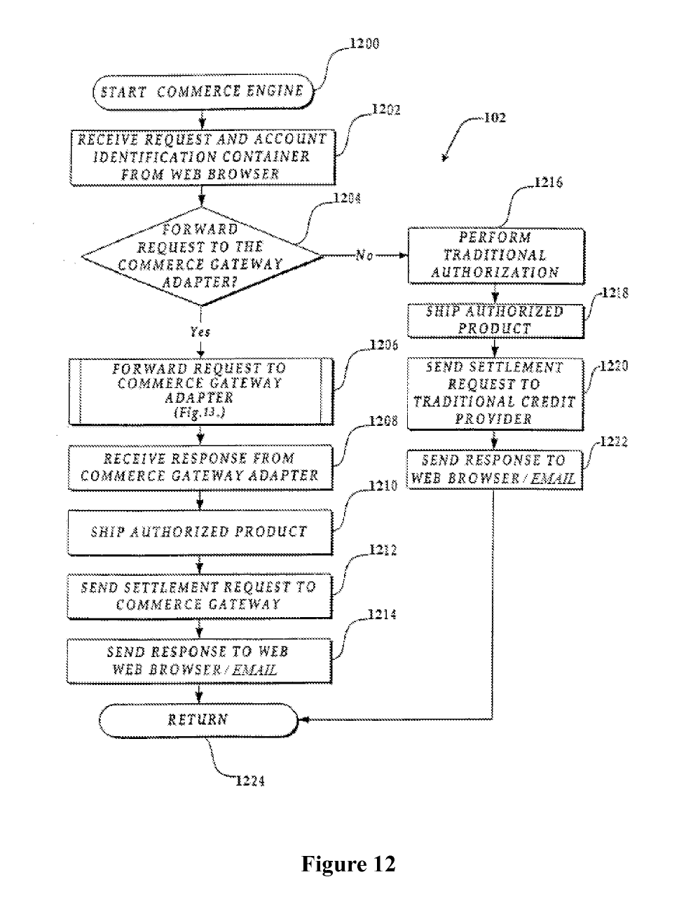

Returning to FIG. 6, after the account and authentication container are sent to the LCM server 104, the logic then proceeds to a block 634 where the logic waits to receive the account identification container from the account identification container generator component of the LCM server 104. Once the account identification container is received from the LCM server 104, the logic proceeds to a block 638 where a purchase request is sent to the commerce engine of the seller server 102 in the form of a request and account identification container for processing as shown in FIG. 12 and described next.

The commerce engine is the component of the seller server 102 that determines whether or not the order will be processed and whether the requested product will ultimately be provided to the buyer. It will be appreciated that commerce engines are well known in the art and are an essential tool for the seller's web store. The commerce engine component and commerce gateway adapter 102 allows the virtual payment system of the present invention to expand existing technology that is currently used for traditional credit systems to encompass the layaway virtual payment account of the present system. It will be further appreciated that while the embodiment shown and described modifies the commerce engine to achieve this functionality (which may be possible through existing application program interface (API) calls of the commerce engine), other embodiments are possible. This expanded commerce engine of the seller server 102 functionality is shown in FIG. 12.

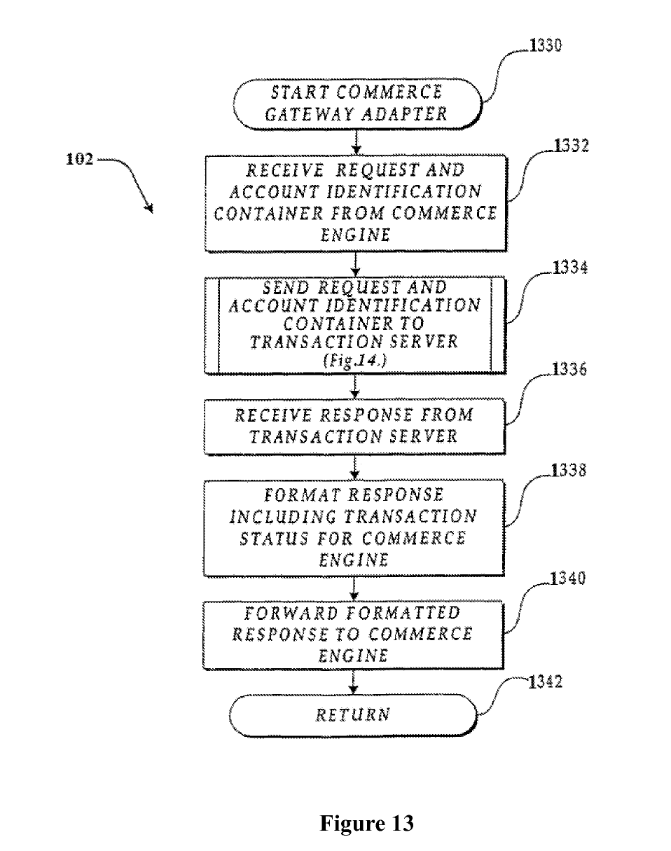

The logic of FIG. 12 begins in a block 1200 and proceeds to a block 1202 where a purchase request and account identification container are received from the web browser of the buyer computer 101a-d. The logic then proceeds to a decision block 1204 where a test is made to determine whether the purchase request should be forwarded to the commerce gateway adapter component of the seller server 102. If the purchase request is to purchase products using a layaway virtual payment account, the request should be forwarded to the commerce gateway adapter component of the seller server 102 for processing in accordance with the virtual payment system of the present invention. In another embodiment, only the request (without the account identification container) is received from the web browser 101a-d in block 1202, and if it is determined in decision block 1204 that the purchase request should be forwarded to the commerce gateway adapter component of the seller server 102, the account identification is then obtained from the web browser 101a-d. In either case, if it is determined in decision block 1204, that the purchase request should be forwarded to the commerce gateway adapter component of the seller server 102, the logic proceeds to a block 1206 where the request is forwarded to the commerce gateway adapter component of the seller server 102. The expanded commerce gateway adapter component of the seller server 102 functionality is shown in more detail in FIG. 13 and described next.

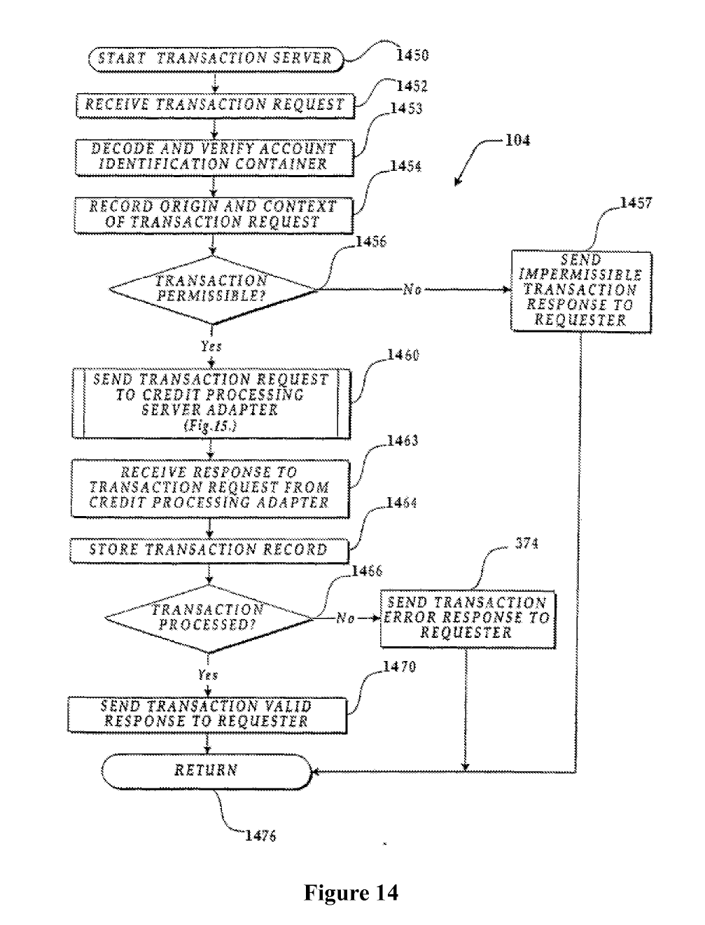

The commerce gateway adapter is a component residing on the seller server 102 that allows the seller server 102 to communicate directly with the transaction server component of the LCM server 104 in order to expand the authorization function of the commerce engine of the seller server 102 to include virtual payment account transactions. Accordingly, the logic of FIG. 13 begins in a block 1330 proceeds to a block 1332 where the forwarded purchase request and account identification container are received from the commerce engine of seller server 102. Next, in a block 1334 the purchase request and account identification container are sent to the transaction server component of the LCM server 104 in the form of a transaction request for further processing as shown in FIG. 14 and described next.

The transaction adapter component of the LCM server 104 is responsible for interfacing with the other components of the system and determining whether or not a requested transaction should be applied to a buyer's virtual payment account. The logic of FIG. 14 begins in a block 1450 and proceeds to a block 1452 where the transaction request is received. Next, in a block 1453 the account identification container is decoded and verified. The origin or source of the request as well as the context, i.e., date and time, of the request are then recorded in memory of the LCM server 104 in a block 1454. Next, the logic proceeds to a decision block 1456 where a test is made to determine whether the requested transaction is permissible. A variety of factors can be considered in making the determination of whether a requested transaction is permissible, for example, credit limit cannot be exceeded.

If the transaction is not permissible, the logic proceeds to a block 1457 where an impermissible transaction message is sent to the requester (e.g., the commerce gateway adapter of the seller server 102 in the context of a purchase request). The logic of FIG. 14 then ends in a block 1476. If, however, the transaction is permissible, the logic proceeds from decision block 1456 to a block 1460 where the transaction request is sent to a credit processing adapter of the credit processing server 107 for further processing as shown in FIG. 15 and described next.

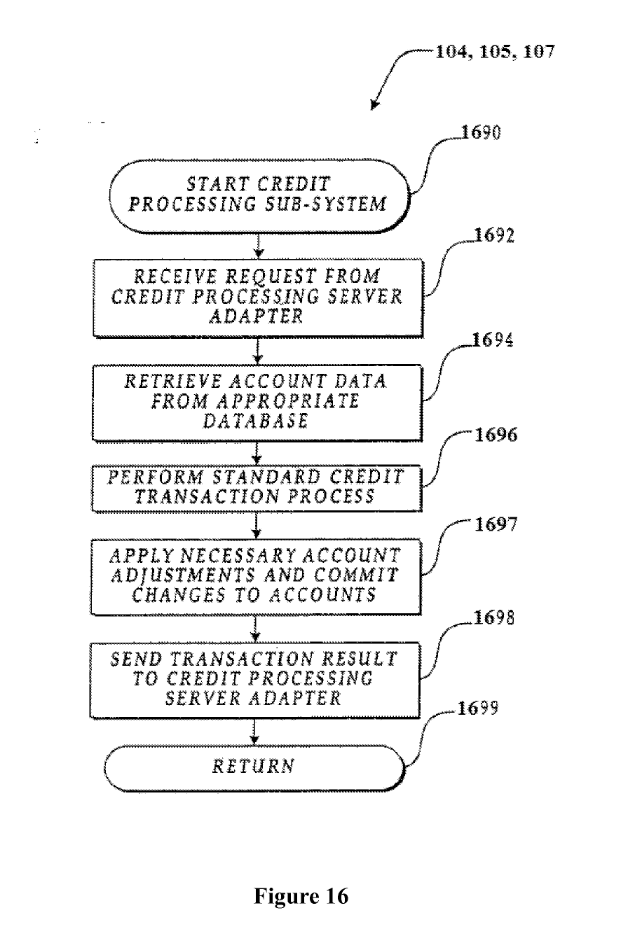

The credit processing server adapter is the component residing on the LCM server 104 that allows the LCM components, such as the transaction server, and the communication server 105 to communicate directly with the various sub-systems of the credit processing server 107, which provide for the application of the requested transaction to the buyer's actual payment account. Accordingly, the logic of FIG. 15 begins in a block 1580 and proceeds to a block 1582 where the request is received. For example, a purchase authorization request or a refund request is received from the transaction server component of the LCM server 104 and a credit information request is received from the communication server 105. The request is then formatted to be compatible with the appropriate credit processing subsystems, i.e., account/billing and the payment processing subsystems of the LCM server 104 and the account enrollment subsystem database of the communication server 105, on the credit processing server 107 in a block 1584. Next, the logic proceeds to a block 1586 where the formatted request is then sent to credit processing server 107 for processing by the appropriate credit processing sub-system, as shown in FIG. 16 and described next.

For any credit processing sub-system, the logic of FIG. 16 begins in a block 1690 and proceeds to a block 1692 where the transaction request is received from the credit processing server 107. Next, account data is retrieved in blocks 1694 and 1696, respectively from the appropriate database 106, e.g., account and financial data. Standard credit transaction processing is then performed in a block 1696. Examples of standard transactions for the account/billing sub-system of the LCM server 104 include: creating and maintaining accounts, including holding account information and account holder information, such as name and address; calculating interest; calculating minimum monthly payments; generating electronic monthly statements; and calculating other charges, known as layaway fees. The layaway fees are the portion of the transaction amount that will go to the provider of the LCM server 104, and can be determined on a fixed amount per transaction basis, or a percentage of transaction amount basis. Examples of standard transactions for the payment processing sub-system of the LCM server 104 include: automatically collecting payments from buyers and applying the payments to the buyer's account; transferring funds between sellers and buyer, for example by interfacing with financial institutions 110 112 114 for automated clearing house (ACH) transactions. Examples of standard transactions for the account enrollment sub-system of the communication server 105 include: obtaining credit information from credit bureaus; providing the credit information to the LCM server 104 for scoring; determining a credit score based on the credit information and providing the score to the LCM server 104; and providing scoring information to the account/billing sub-system of the LCM server 104 for account creation.

The logic then proceeds to a block 1697 where necessary account adjustments are applied, if applicable. For example, the account balance will be reduced by the amount of an authorized purchase transaction. In one embodiment of the present invention, reward points are accrued at the time of purchase, but committed later, for example during the periodic, e.g., monthly, statement preparation process. Alternatively, reward points may not accrue until payment is made for the product to which the points are attributed. Next, the transaction result, such as the credit information or the purchase authorization, is sent to the credit processing server 107 in a block 1698. The logic of FIG. 16 then ends in a block 1699 and processing returns to FIG. 15.

Returning to FIG. 15, the result of the transaction request is received from the credit processing sub-system of the credit processing server 107 in a block 1587. Next, in a block 1588, the result is then returned to requester, e.g., the result of a purchase authorization request is returned to the transaction server component of the LCM server 104 and credit information, for example, a credit limit, is returned to the communication server 105 in response to request for a credit information request to be used for establishing a buyer's account. The logic of FIG. 15 then ends in a block 1589 and processing returns to the requester, e.g., transaction server component of the LCM server 104 (FIG. 14) or communication server 105 (FIG. 16).

Returning to FIG. 14, once the transaction server receives the response to its transaction request, e.g., authorization result of a purchase request, from the credit processing adapter in a block 1463, the logic proceeds to a block 1464 where the transaction record, for example purchase information including amount of purchase, is stored in memory of the LCM server 104. The logic then proceeds to a decision block 1466, where a test is made to determine if the transaction was successfully processed. If so, the logic proceeds to a block 1470 where a transaction response with a valid status is then sent to the requester (e.g., the commerce gateway adapter of the seller server 102 or the web browser 101a-d, whichever the case may be). If the transaction was not successfully processed, the logic proceeds from decision block 1466 to a block 1474 where a transaction response with an error status is then returned to the requester in a block 1476.

After a valid transaction response 1470, an error transaction response 1474, or an impermissible transaction response 1457 is sent to the requester, the logic of FIG. 14 ends in block 1476 and processing returns to the requester. In the case of a purchase request, the requester is the commerce gateway adapter of the seller server 102 in block 1476. In one exemplary embodiment, a record of all transactions is stored in the financial database subsystem of the database 106.

Returning to FIG. 13, after the response to the purchase request made by the commerce gateway adapter 102 is received from the transaction server in a block 1336, the logic proceeds to a block 1338 where the response including the transaction status is formatted to be compatible with the commerce engine of the seller server 102. The formatted response is then forwarded to the commerce engine in a block 1340. The logic of FIG. 13 then ends in a block 1342 and processing returns to the commerce engine of the seller server 102 in FIG. 12.

Returning to FIG. 12, once a response is received by the commerce engine of the seller server 102 from the commerce gateway adapter of the seller server 102 in a block 1208, the authorized and ordered product is shipped to the secure storage facility in a block 1210. Once shipment is complete, the logic then proceeds to a block 1212 where a settlement request is sent to the commerce gateway of the seller server 102 in order to initiate movement of funds. In an actual embodiment of the present invention, the seller submits the transaction into a settlement batch for payment when the settlement batch for that seller is next processed. The timing of the processing could be that night or at a later date based on the contract, i.e., terms of the purchase transaction. Settlement transactions are described in FIG. 12 in more detail below with reference to FIG. 12.

Returning to FIG. 12, in a block 1214, a response confirming fulfillment of the order is sent to the Web browser of the buyer's computer 101a-d. The logic of FIG. 12 then ends in a block 1224.

However, if at decision block 1204, it is determined that the purchase request should not be forwarded to the commerce gateway 104; e.g., the on-line seller is not registered, the logic proceeds to a block 1216 where standard commerce engine processing is performed. More specifically, in block 1216 traditional credit authorization is performed such as approval or denial for the use of the Layaway Purchase Card (LPC) for the specified purchase amount. Next, the authorized goods are shipped in a block 1218 to the secure storage facility. The logic then proceeds to a block 1220 where a settlement request is sent to the LPC credit provider. A response confirming fulfillment of the order is then sent to the Web browser of the buyer computer 101a-d or e-mailed to the buyers registered e-mail address in a block 1222. The logic of FIG. 12 then ends in block 1224 and processing returns to FIG. 6.

Returning to FIG. 6, once the Web browser of the buyer computer 101a-d receives a response to its purchase request in a block 640, the logic proceeds to a block 641 where an order confirmation Web page 595 is displayed as shown in FIG. 5E. The logic of FIG. 6 then ends in block 642.

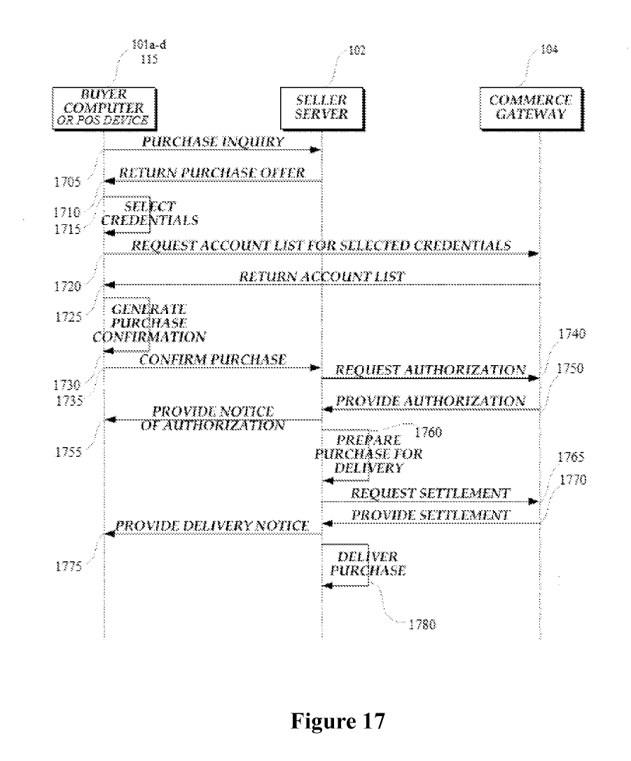

FIG. 17 is a diagram illustrating the actions taken by the buyer using a computer 101a-d or point-of-sale (POS) system 115 through use of the LPC, the seller server 102, and the commerce gateway 104 for ordering products using a virtual payment account system. This diagram presents a high-level view of the detailed processing shown in the flow charts described above. In response to an inquiry into purchasing a product 1705, a seller returns a purchase offer 1710 to the buyer's computer 101a-d or point-of sale system 115. At this point, the buyer has the option of beginning the purchasing process as shown in FIG. 6. To continue, the buyer authenticator checks to see which credentials, e.g. certificates, are available to the buyer and selects all available credentials to be used by the commerce gateway 1715 to authenticate the buyer. The buyer's computer 101a-d or point-of sale system 115 then requests a list of all accounts or sub-accounts 1720 for these credentials from the commerce gateway 104. The commerce gateway 104 returns only those accounts that are usable by the buyer 1725 using the selected credentials. The buyer's computer 101a-d or point-of sale system 115 then generates a purchase confirmation 1730 using one of the accounts on the list returned from the commerce gateway 104. Buyer's computer 101a-d or point-of sale system 115 then sends the purchase confirmation 1735 to the seller server 102. The seller server 102 requests authorization 1740 from the commerce gateway to verify that the purchase confirmation is valid. The commerce gateway then returns an authorization 1750 that the purchase confirmation is valid. The seller server 102 may then notify 1755 the buyer's computer 101a-d or point-of sale system 115 that the purchase confirmation was authorized. The seller server then prepares the purchase for delivery 1760. At this point, the seller may request a settlement transaction 1765 from the commerce gateway 102 which would then provide a settlement transaction 1770 back to the seller server 102. The seller server 102 may then notify 1775 the buyer's computer 101a-d or point-of sale system 115 of delivery details. Finally, the good(s) or service(s) that the buyer purchased are delivered 1780.

If the seller is an auction web site, the authorization 1740 sent by the commerce gateway 104 to the seller server 102 includes information such as a buyer account identification, a seller identification, a seller sale offering, a buyer authentication, a seller authentication, and a master identification, i.e., identification of the commerce gateway 104 provider. Particular to this type of response is an expiration date/time that is used to signal the shorter of the maximum times that the buyer and the seller are willing to “reserve” finds associated with this transaction. If the transaction, i.e., settlement request 1765, is not received by the commerce gateway 104 before the expiration date/time of the transaction, the products and/or finds will be released back to their owners. At a later time, once the buyer has committed to the purchase, the buyer releases an authorization to the provider of the commerce gateway 104 knowing that the seller has proven ability to ship the products on demand without delay. This initiates the actual settlement of funds and triggers payment to the seller in the next settlement batch, without any further interaction with the seller. This payment method supports buyer-initiated, pre-approved purchases with expiration date/time, such as auction and gift-certificate purchases.

It will be appreciated that FIG. 17 illustrates processing of a valid purchase transaction. If there is an error at any time during the processing; e.g., buyer is not authorized because he or she is not a registered buyer, has exceeded his or her spending limit, etc., processing will terminate after an appropriate error response has been returned to the buyer's computer 101a-d via the Web browser or the point-of sale system 115 display.

### Purchasing Products from a Non-Registered On-Line Retailer

In another actual embodiment of the present invention depicted in FIGS. 5A-5E, the buyer may “surf the web” and visit a non-registered seller's web site, such as “Virtual Store,” 117, 500 using the web browser on the buyer computer 101a-d. Once the buyer visits a registered seller's web site, the buyer may order and pay for products offered from that web site using his or her Layaway Purchase Card (LPC) that is secured to the buyer's virtual payment account. More specifically, a buyer using buyer computer 101a-d and Web browser on the buyer computer 101a-d may retrieve the web page 500 shown in FIG. 5A from the registered on-line seller web site fictitiously known as “Virtual Store.” The buyer makes a selection of a particular product 505 by manipulating a graphics cursor with a pointing device, such as a mouse above the selection 510 and “single-clicking.” It will be appreciated that other pages, for example, a query, page in which the buyer requests products by a keyword, may be displayed. It will also be appreciated that the web page 500 shown in FIG. 5A is a simplified example. It is common for a seller site to allow a buyer to select multiple products and place them in a “shopping cart.” The buyer can then view the items in the cart and, if desired, remove items from the cart. Once the buyer has selected the desired items for purchase, the buyer indicates a desire to purchase the selected items, for example, by clicking an “OK” or a “Buy” button. In the simplified example shown in FIG. 5A, the buyer selects an item, such as the Virtual Store Personal Computer 505 and presses the “Order” button 510 to initiate the purchase transaction.

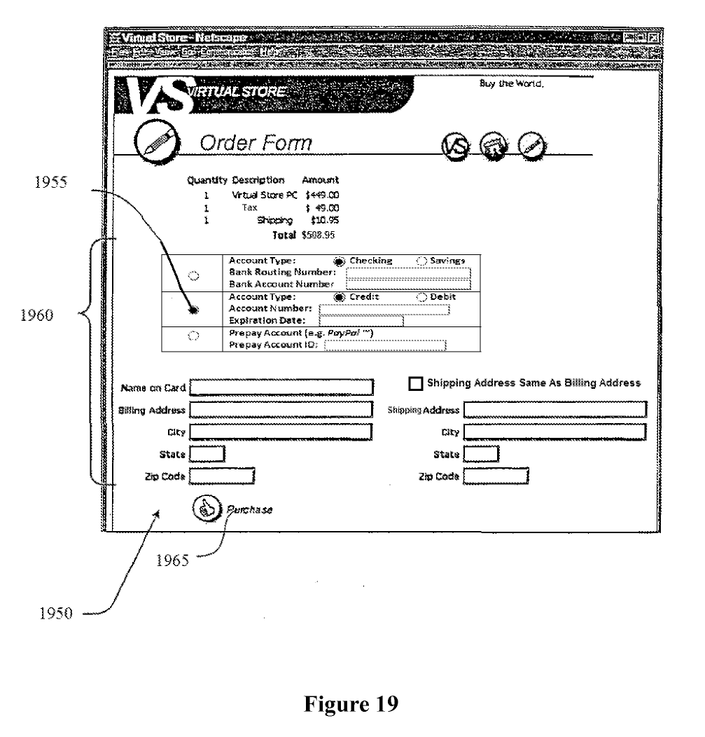

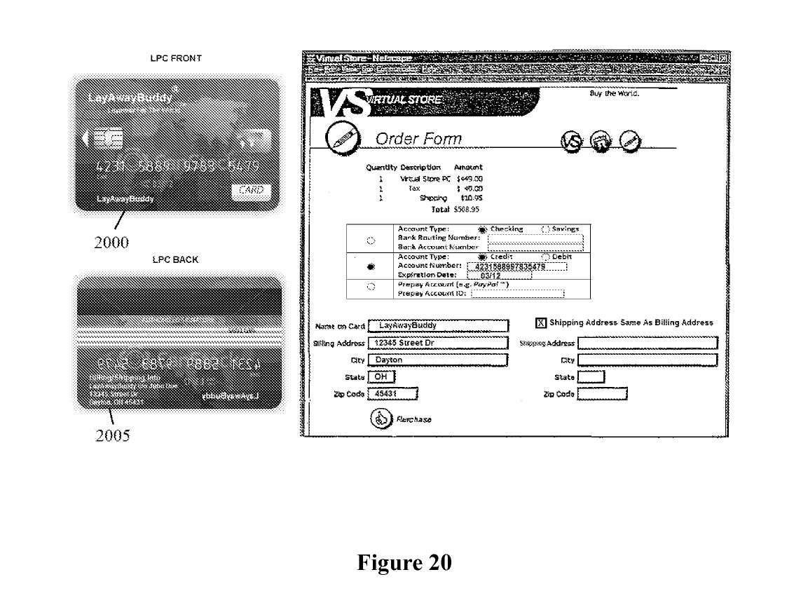

After initiating the purchase transaction or “Checking Out,” the seller server 102 provides the web browser of the buyer's computer 101a-d with the web page 1950 shown in FIG. 19 which requests the buyer's billing and shipping information 1960, such as a street address, from the buyer. Additionally the web page 1950 includes various payment options, i.e., major credit cards, such as VISA® or MASTERCARD®, Prepay option, e.g., PayPal®, debit card such as VISA®, or checking or savings account with electronic transmission of credit and/or account information. In accordance with the present invention, a layaway virtual payment account option is not displayed as a payment option for non-registered sellers. In this case, the buyer selects the credit payment option 1955 and then enters buyer's billing and applicable payment information for the type of payment option selected 1960 from the information provided on the front 2000 and back 2005 of the issued LPC shown in FIG. 20. The buyer can continue by clicking on the “Purchase” option 1965. The buyer may be presented with an order confirmation screen 2100 as shown in FIG. 21 indicating the shipping location for the secure storage facility 108 where the layaway purchase will be held for the duration of the layaway transaction period which automatically defaults to six months for non-registered on-line retailers.

In an actual embodiment of the present invention, the authenticator of the buyer's internet connected device 101a-d when the credit payment option is selected is similar to the authentication of the buyer's internet connected devices 101a-d when the virtual payment account layaway option 1755 is selected for a registered buyer. Using the information provided on the front 2000 and back 2005 of the issued LPC shown in FIG. 20, FIG. 6 block 630 begins the logic implemented by the web browser installed on the buyer computer (101a-d) when the credit payment option 1955 is selected for a registered buyer.

In an actual embodiment of the present invention for the authenticator of the buyer's internet connected device 101a-d for the credit payment option using the LPC shown in FIG. 20, the buyer's digital ID or user name along with an authenticating pass phrase or password 572 for the virtual layaway account is not required. If the information provided on the front 2000 and back 2005 of the issued LPC shown in FIG. 20 is authenticated, in response, the non-registered seller's server 102 configures the total cost of the order using only the purchase price, shipping costs and applicable sales taxes and the buyer is presented with a confirmation screen 590 as shown in FIG. 5C, less the down payment information, layaway, secure storage and interest fees. After authorizing the purchase, the buyer may be presented with the non-registered seller's order confirmation screen 595 as shown in FIG. 5E indicating the shipping location which is the secure storage facility 108 where the layaway purchase will be held for the duration of the layaway transaction period.

During the authentication process for an on-line purchase from a non-registered seller using the issued LPC (FIG. 20), the LCM server 104 invokes the Layaway Calculator 580 software shown in FIG. 5B on behalf of the registered buyer. The retail sale amount, taxes, and shipping cost 550 as shown in FIG. 5B are “auto” entered into the layaway calculator fields 581. The information from web page 325 as shown in FIG. 3F, i.e., the annual interest rate, layaway fee and minimum down payment 582 that will be paid to the LCM 104 are “auto” entered in fields of FIG. 5B. The layaway calculator 580 auto-calculates the secure storage fee 583 as equal to the shipping fee or a minimum storage fee, whichever is greater. The LCM server 104 then auto-calculates the layaway and interest fees 586 followed by the total initial down payment 587 and additional monthly payments 588 per the layaway contract period 584. In response, the LCM server 104 configures the total cost of the order, from the layaway calculator 580, and the buyer is e-mailed the confirmation screen 590 as shown in FIG. 5C. At this time, the initial down payment is automatically deducted from the buyer's specified bank, debit, or credit account 109 110 and paid to the LCM financial institution 111 112 whereby the layaway transaction is secured and the buyer is informed of the down payment transaction via e-mail.

As stated previously, number of months of the layaway contract period 584 defaults to six months for an online non-registered seller purchase via the credit payment option using the issued LPC. The buyer has the option of adjusting the layaway contract period by accessing their VPA on-line or requesting the layaway period adjustment via e-mail or telephone call to a customer service representative using the issued order confirmation or reference number. Any changes to the layaway contract period initiates a recalculation of previously calculated transaction fees with the requisite adjustment, debit or credit, made to the registered buyer's account.

### Purchasing Products from a Registered Physical Retailer

In another actual embodiment of the present invention, the buyer may visit a registered seller's physical or “brick and mortar” store,” 116. Once the buyer visits a registered seller's physical retail store 116, the buyer may order and pay for products offered in that physical retail store using his or her Layaway Purchase Card (LPC) shown in FIG. 20 that is secured to the buyer's virtual payment account. The buyer makes a selection of particular products and places them in a shopping cart. Once the buyer has finished selecting the desired items for purchase, the buyer proceeds to the Customer Service counter to initiate the purchase transaction or “Checking Out”.

After initiating the purchase transaction or “Checking Out,” the buyer is presented various payment options, i.e., major credit cards, such as VISA® or MASTERCARD® or debit card such as VISA® on the retail store's point-of-sale (POS) device 115 shown in FIG. 22A. In accordance with the present invention, a layaway virtual payment account option is displayed as a payment option for registered sellers. In this case, the buyer selects the layaway virtual payment option 2200 on the point-of-sale (POS) device 115 shown in FIG. 22A and then “swipes” the issued LPC shown in FIG. 20 so that the magnetic strip on the back of the card 2005 comes in contact with the POS device's 115 magnetic card reader shown in FIG. 22A. The buyer is then required to enter the four digit personal identification number, PIN, that was created during the VPA registration process and select the layaway contract period in block 2205 shown in FIG. 22B. If the transaction is authenticated, an order confirmation screen 2210 is shown in FIG. 22C indicating the shipping location for the secure storage facility 118 where the layaway purchase will be held for the duration of the layaway transaction period.

In an actual embodiment of the present invention for the authenticator of the LPC shown in FIG. 20, when the card is swiped at a registered physical retailer's POS device (FIG. 22A), the authentication is similar to the authentication of the buyer's internet connected devices 101a-d when the virtual payment account layaway option 555 is selected for a registered buyer. Using the information coded in the magnetic stripe on the back of 2005 of the issued LPC shown in FIG. 20, FIG. 6 again illustrates the logic implemented when the buyer selects the layaway virtual payment option 2200 on the point-of-sale (POS) device 115 shown in FIG. 22A of a registered physical retail establishment.

In an actual embodiment of the present invention after the authentication of the buyer's LPC (FIG. 20) purchase at a registered physical retailer 116, the registered physical retail seller's server 113 configures the total cost of the order using the purchase price, shipping costs and applicable sales taxes that will be paid to the seller's financial institution 114.

During the authentication process for a physical retail purchase from a registered buyer using the issued LPC (FIG. 20), the LCM server 104 invokes the Layaway Calculator 580 software shown in FIG. 5B on behalf of the registered buyer. The retail sale amount, taxes, and shipping cost 550 as shown in FIG. 5B are “auto” entered into the layaway calculator fields 581. The information from web page 325 as shown in FIG. 3F, i.e., the annual interest rate, layaway fee and minimum down payment 582 that will be paid to the LCM financial institution 112 are “auto” entered in fields of FIG. 5B. The layaway calculator 580 auto-calculates the secure storage fee 583 as equal to the shipping fee or a minimum storage fee, whichever is greater. The LCM server 104 then auto-calculates the layaway and interest fees 586 followed by the total initial down payment 587 and additional monthly payments 588 per the layaway contract period 584. In response, the LCM server 104 configures the total cost of the order, from the layaway calculator 580, and the buyer is shown the total order screen 2215 and confirmation screen shown in FIG. 5C on the point-of-sale (POS) device 115 shown in FIG. 1 and POS screen 2220 shown in FIG. 22D. At this time, the initial down payment is automatically deducted from the buyer's specified bank, debit, or credit account 109 110 and paid to the LCM financial institution 111 112 whereby the layaway transaction is secured and the buyer is informed of the down payment transaction via e-mail.

After authorizing the purchase, the registered seller automatically generates a shipping label shown in FIG. 23 for the contracted shipping company indicating the shipping location where the layaway purchase will be held for the duration of the layaway transaction period and then prepares the purchased merchandise for shipment.

As stated previously, the buyer has the option of adjusting the layaway contract period by accessing their layaway VPA on-line or requesting the layaway period adjustment via e-mail or telephone call to a customer service representative using the issued order confirmation or reference number. Any changes to the layaway contract period initiates a recalculation of previously calculated transaction fees with the requisite adjustment, debit or credit, made to the registered buyer's account.

### Registered Seller Settlement Transaction

When a seller establishes a seller account, a contract is formed defining the relationship between the seller and the LCM commerce gateway provider. That contract defines the terms, such as when payments will be funded and what fee shall be given to the commerce gateway provider. The commerce gateway fee can be a per transaction fee or a percentage fee based on the amount of a transaction. The logic for settlement transactions for a virtual payment account is similar to the logic used for processing standard credit card settlement transactions. After the seller ships the product, the seller sends a settlement transaction to the commerce gateway 104 as shown in FIG. 24. It will be appreciated that the logic performed by the seller financial server 113 can be performed by the commerce engine component, or some other component, for example, a Web browser (not shown) residing on the seller financial server 113.

FIG. 24 illustrates the logic implemented by seller financial server 113 when the seller wishes to perform a settlement transaction. The logic begins in a block 2430 and proceeds to a block 2432 where a secure connection between the seller computer 113 and commerce gateway 104 is established, using the same logic shown and described with reference to the buyer in block 622 of FIG. 6. The logic then proceeds to a block 2434 where the seller authenticator process is run. The seller authenticator process is similar to the buyer authenticator process shown in FIG. 7 and described above. Next, in a decision block 2436 a test is made to determine if the seller is a registered participant (i.e., seller's digital certificate was issued by the commerce gateway provider, seller's digital certificate has not expired and seller's digital certificate has not been revoked). If not, the logic proceeds to a block 2438 where a seller authentication error message is displayed on the seller server display 113, for example, via a Web browser. The logic of FIG. 24 then ends in a block 2448.

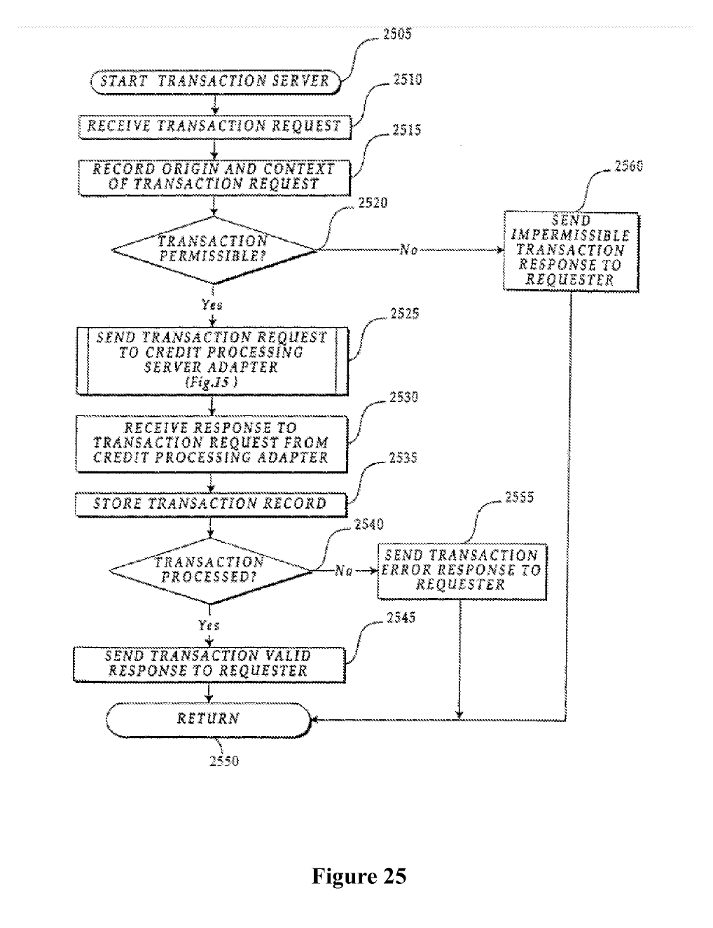

If the seller authenticator process is successful, the logic proceeds from decision block 2436 to a block 2444 where a settlement request is sent to the transaction server on the commerce gateway 104. As shown and described in FIG. 25, the transaction server forwards the request to the credit processing server adapter 107, which in turn forwards the transaction request to the appropriate credit processing sub-system. In the case of a settlement transaction request, the payment processing sub-system 107 processes the transaction. The payment processing sub-system forwards the settlement request to the LCM financial institution 112. The LCM financial institution funds the transactions into the commerce gateway provider's account. The commerce gateway provider takes its percentage and pays the sellers 114 their portion. The LCM financial institution 112 waits for their billing cycle, e.g., monthly, and then in accordance with the terms of the layaway VPA, automatically deducts the monthly payments on the remaining balance from a specified bank, debit, or credit account of the buyer's financial institution 110.

The logic of FIG. 25 begins in a block 2505 and proceeds to a block 2510 where the settlement request is received. The origin or source of the settlement request as well as the context, i.e., date and time, of the request are then recorded in memory of the commerce gateway 104 in a block 2515. Next, the logic proceeds to a decision block 2520 where a test is made to determine whether the requested settlement is permissible. A variety of factors can be considered in making the determination of whether a requested settlement is permissible. Some factors might include a settlement request for a transaction that did not have a purchase confirmation from a buyer, that had a purchase confirmation from a buyer whose account did not hold sufficient funds, for an auction settlement whose time had expired or whose credentials were no longer valid. It will be appreciated that yet other factors may cause a settlement transaction to be impermissible. If the transaction is not permissible, the logic proceeds to a block 2560 where an impermissible settlement request message is sent to the requester, i.e., the seller, in this case. If, however, the transaction is permissible, the logic proceeds from decision block 2520 to a block 2525 where the transaction request is sent to a credit processing server adapter 107 for further processing as shown in FIG. 15 and described above. Continuing in FIG. 25, once the transaction server receives the response to its transaction request, e.g., authorization result of a settlement request, from the credit processing adapter in a block 2530, the logic proceeds to a block 2535 where a transaction record, for example purchase information including amount of purchase, is stored in memory of the commerce gateway 104. The logic then proceeds to a decision block 2540, where a test is made to determine if the transaction was successfully processed. If so, the logic proceeds to a block 2545 where a transaction response with a valid status is then sent to the requester, i.e., the seller in this case. If the transaction was not successfully processed, the logic proceeds from decision block 2540 to a block 2555 where a transaction response with an error status is then returned to the requester.

After a valid transaction response 2545, an error transaction response 2555, or an impermissible transaction response 2560 is sent to the requester, the logic of FIG. 25 ends in block 2550 and processing returns to the requester.

Referring back to FIG. 24, after the transaction server component of the LCM server 104 has processed the settlement transaction and provided the results of the settlement transaction to the seller's computer 113, the result of the settlement transaction is displayed on the seller's display 113, for example, via the seller financial server's Web browser. The logic of FIG. 24 then ends in block 2448.

### Refund Transaction without Product Return

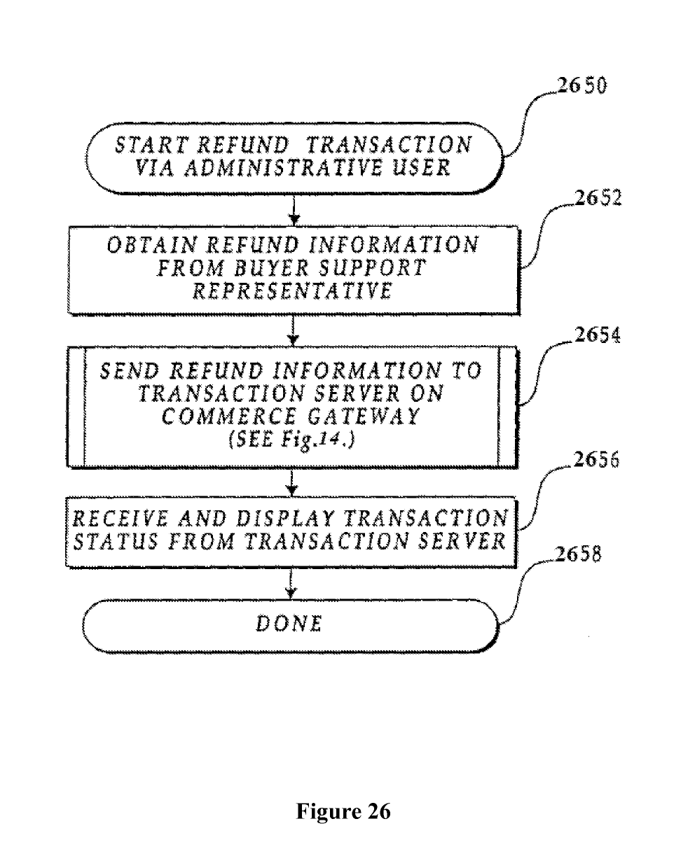

FIG. 26 illustrates the logic implemented by the present invention when a refund transaction is initiated, for example, when a buyer disputes a charge on his or her layaway virtual payment account and the dispute does not involve the return of the purchased merchandise. As with any payment dispute, it must be determined whether the buyer will receive all or a portion of the disputed amount. The determination of whether the dispute has merit is determined by the seller. If the seller determines that the dispute has merit, the seller notifies a customer service representative and a refund transaction is initiated. In the embodiment shown in FIG. 26 and described herein, if it is determined that an amount disputed by a buyer is subject to a refund, a seller's customer service representative initiates the refund, or chargeback transaction via the administrative computer within the on-line 117 or physical 116 retailer's administrative facility. In one actual embodiment, the administrative computer is a “dumb terminal” by which the seller's customer service representative enters information directly into the transaction server component on the commerce gateway 104. In another embodiment, the administrative computer may have a Web browser that allows the administrator to enter the information using Web browsers at the on-line 117 or physical 116 retailer that are connected behind the firewall.

Referring to FIG. 26, the logic begins in a block 2650 and proceeds to a block 2652 where the refund information including account, sub-account and amount is obtained. The refund transaction information is then sent to the transaction server component of the LCM server 104 by the administrative computer in block 2654 in the form of a refund request. Transaction server component of the LCM server 104 processing is shown and described with reference to FIG. 14.

As also noted above, in processing the refund request, the transaction server component of the LCM server 104 will forward a transaction request to the credit processing server 107 for processing by the account/billing sub-system of the LCM server 104 as shown in FIG. 16. A refund applied to a buyer's layaway virtual payment account causes the buyer's balance to decrease by the amount of the refund payment. The Layaway Calculator 580 then recalculates the remaining payments based on the refund amount and issues an account credit or refund check if the layaway transaction period has been completed. Still referring to FIG. 26, after the transaction server component has processed the refund transaction, the result of the transaction processing is received and displayed by the administrative computer connected to the LCM server 104. The logic of FIG. 26 then ends in a block 2658. Just like the purchase transaction, the refund transaction can be initiated by the buyer via the Web browser 101a-d by accessing their layaway VPA on-line or via e-mail or telephone call to the LCM account manager's customer service representative using the issued order confirmation or reference number. In addition, the buyer can be notified by other means, for example by sending an e-mail message to the buyer's computer 101a-d. It will also be appreciated that in yet other embodiments of the present invention, the seller financial server 113 may initiate the refund request as opposed to the administrative computer.

### Refund Transaction with Product Return

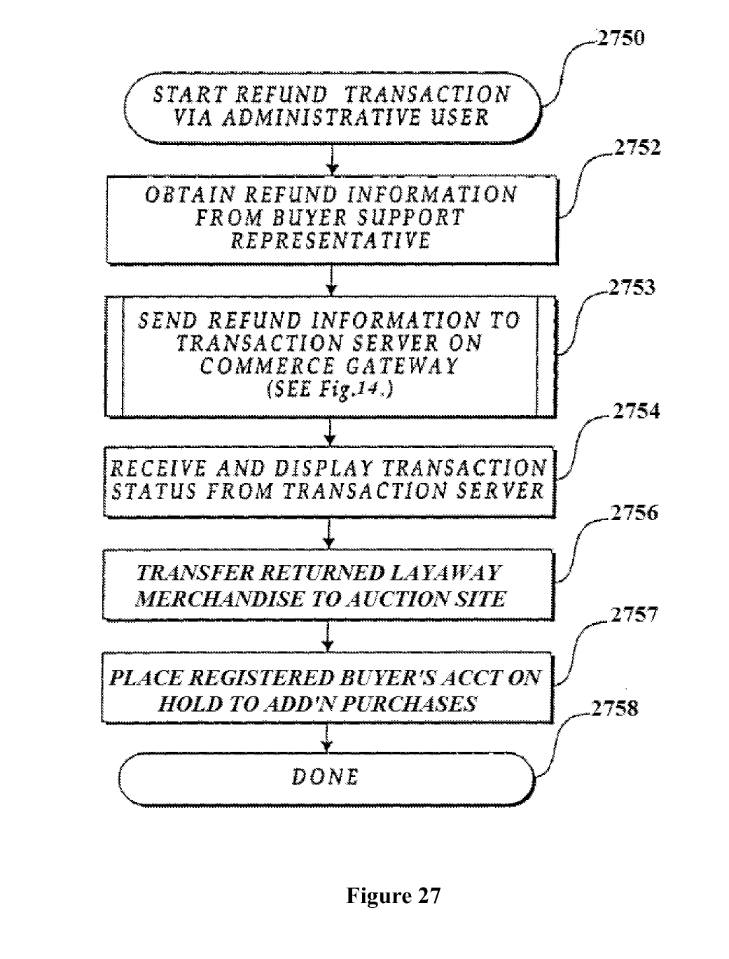

FIG. 27 illustrates the logic implemented by the present invention when a refund transaction is initiated and the refund involves the return of the purchased merchandise and canceling of the layaway contract. The present invention provides a method and system for single-action refunds of purchased merchandise using the buyer's internet connected devices 101a-d and the transaction server component of the LCM server 104.

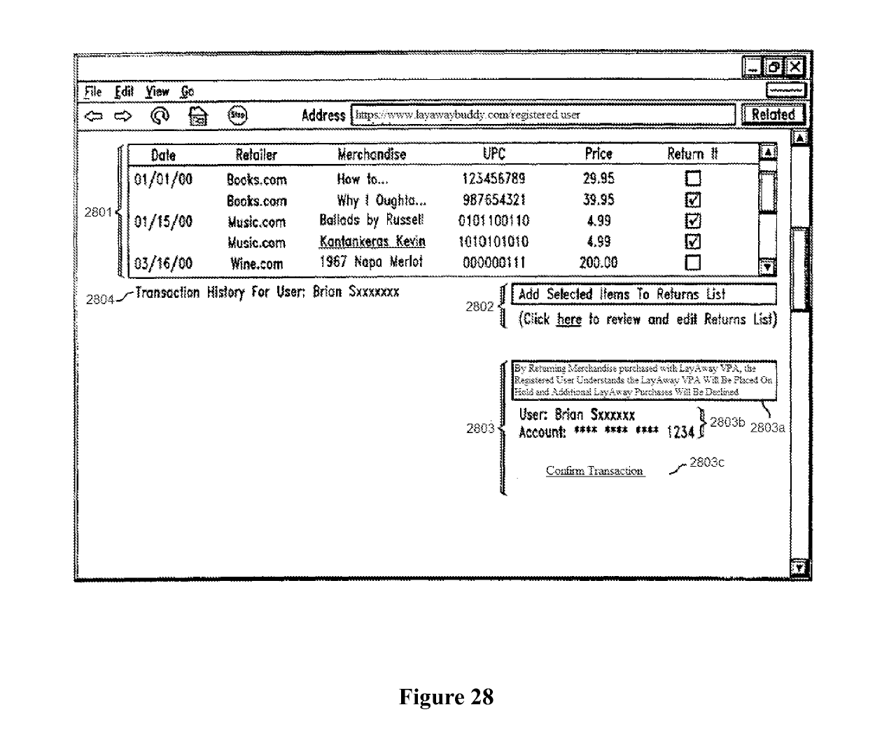

The single-action refund capability of the present invention shown in FIG. 28 reduces the number of user interactions needed to obtain a refund for an item and reduces the amount of sensitive information that is transmitted between a buyer's internet connected devices 101a-d and the transaction server component of the LCM server 104.

When single-action returns are enabled, the user need only perform a single action (e.g., click a mouse button) to process the return of selected item(s). When the registered user performs that single action, the buyer's internet connected the devices 101a-d and the transaction server component of the LCM server 104 notifies the LCM server 104 system. The server system then preferably completes the merchandise return by adding the user-specific return information for the user that is mapped to that registered user's identifier to the item return information (e.g., product identifier, retailer, credit account, etc.) shown in block 2801. Also, since the LCM server 104 identifies a registered user-preference profile stored at the server system, there is no need for sensitive information to be transmitted via the Internet or other communications medium.

As also noted above, in processing the refund request, the transaction server component of the LCM server 104 will forward a transaction request to the credit processing server 107 for processing by the account/billing sub-system of the LCM server 104 as shown in FIG. 16. A credit refund applied to a buyer's layaway virtual payment account causes the buyer's balance to decrease by the amount of the refund payment. The Layaway Calculator 580 then recalculates the refund amount and issues an account credit less fees and interests. Still referring to FIG. 27, after the transaction server component has processed the refund transaction, the result of the transaction processing is received and displayed by the administrative computer connected to the LCM server 104. If the registered user has remaining layaway transactions, the Layaway Calculator 580 recalculates the remaining payments based on the refund amount and issues an account credit.

The refund transaction can be initiated by e-mail or telephone call to the LCM account manager's customer service representative using the issued order confirmation or reference number. The logic of FIG. 27 then ends in block 2756 with the transfer of the canceled layaway merchandise to the on-line auction and direct merchandise purchase web site on the LCM server 104 and in block 2757 with the placement of the layaway VPA on hold for additional layaway purchases. The layaway VPA can only be considered for reinstatement after the canceled layaway merchandise has been sold on the on-line auction and direct merchandise purchase web site on the LCM server 104 and reinstatement is at the discretion of the LCM account managers.

### Default Transactions

A registered buyer's layaway VPA is considered in default when the system fails to automatically deduct the monthly payments from the specified bank, debit, or credit account 109 110 and after attempts by the LCM account manager's customer service representative using the issued order confirmation or reference number to contact the registered buyer by e-mail or telephone call to make the account current fail.

The result of a default account transaction is the cancellation of all open layaway contracts and the transfer of the canceled layaway merchandise to the on-line auction and direct merchandise purchase web site as shown in block 2756 of FIG. 27 and the placement of the layaway VPA on hold for additional layaway purchases as shown in block 2757.

For accounts in default, the transaction server component of the LCM server 104 will forward a transaction request to the credit processing server 107 for processing by the account/billing sub-system of the LCM server 104 as shown in FIG. 16. A credit refund applied to the buyer's layaway virtual payment account causes the buyer's balance to decrease by the amount of the refund payment. The Layaway Calculator 580 then recalculates the refund amount and issues an account credit less applicable fees and interests and the initial down payment that the registered buyer forfeits under the terms of the default transaction agreement.

The defaulted layaway VPA can only be considered for reinstatement after the registered buyer contacts a LCM account manager's customer service representative with an explanation as to why the account was allowed to go into default and the canceled layaway merchandise has been sold on the on-line auction and direct merchandise purchase web site on the LCM server 104. Reinstatement is at the discretion of the LCM account managers.

### Direct Purchase or Purchase Via Auction of Returned or Canceled Layaway Products

The exemplary embodiment of the present invention provides an electronic auction method and system for presenting returned or canceled layaway merchandise for sale at auction to customers over an electronic network, such as the Internet's World Wide Web. Using the home web page 300 shown in FIG. 3A, the buyer selects the hyper link to start to the Layaway Auction site. Potential customers are presented with a series of descriptive merchandise catalog pages through which they may navigate to find items (lots) of interest. Upon finding a lot of interest, customers may click a button on screen to display a form for placing a bid on the lot. After submitting this bid, the electronic auction system records the bid and updates the lot's merchandise catalog page to show the current high bid or bids and to whom such bids are attributable. When the auction is closed, after a period of no bidding activity, at a predetermined time, or when a desired sales volume is reached, the electronic auction system notifies the winning and losing bidders by electronic mail and posts a list of the winning bidders on the closed lot's merchandise catalog page. In another embodiment, the buyer may presented with a “Buy Direct” price that allows the buyer to purchase the merchandise right away at a set price without waiting for a listing to end.

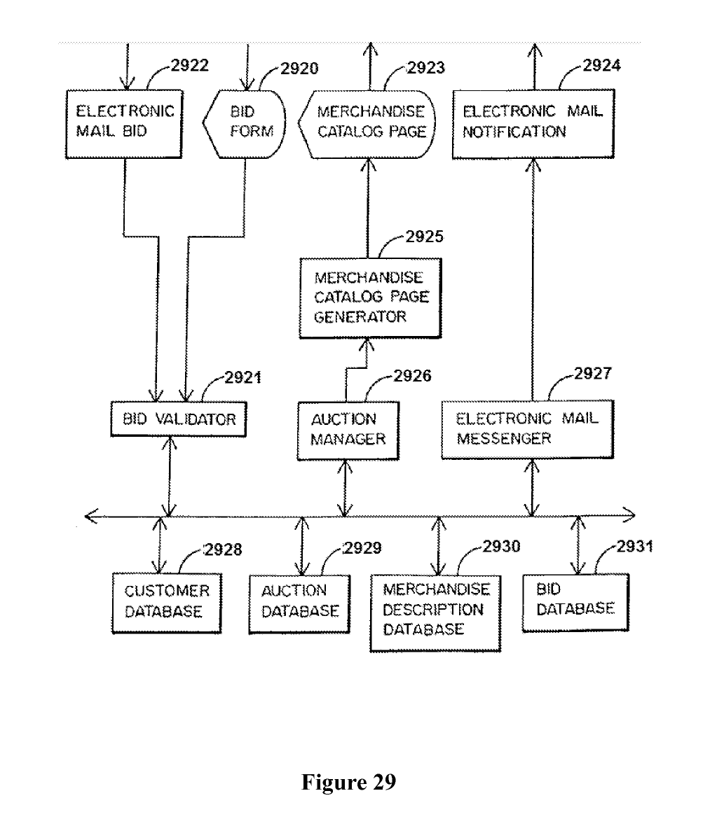

FIG. 29 illustrates a high level block diagram of the electronic auction system according to one embodiment of the present invention. As shown, information from bid form 2920 is received by the electronic auction system where it is processed by bid validator 2921. Bid validator 2921 examines the bid information entered by the customer on bid form 2920 to ensure that the bid is properly formatted, all necessary data is present, and the data values entered look credible. Exemplary functions of bid validator 2921 include verifying credit card information entered by the customer during the application process shown in FIGS. 3A-3H, checking that a complete name and shipping address has been entered, that the proper state abbreviation and zip code have been entered, that an appropriate bid amount has been entered, and that a telephone or facsimile number has been entered. Once the bid information has been validated, the bid validator 2921 places the bid in bid database 2931.

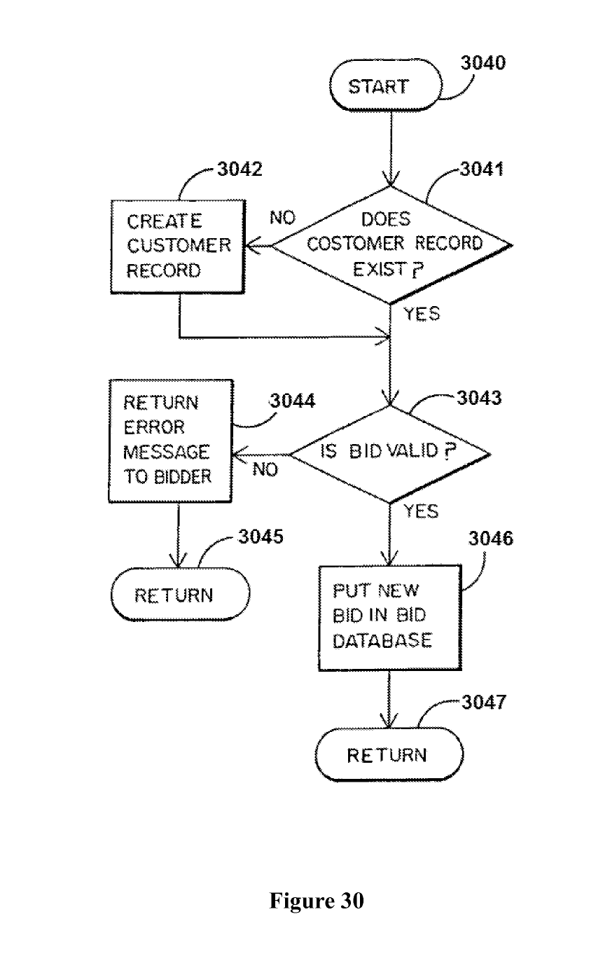

FIG. 30 illustrates in detail an exemplary procedure of bid validation as accomplished by bid validator 2921 shown in FIG. 29. A bid is received by bid validator 2921 and the customer is looked up at step 3041 in customer database 2928. If no customer record exists for the customer then a new customer record is created 3042 and placed in customer database 2928. From there, the bid information is validated 3043 as previously described. If the bid data includes one or more errors, then an error message is returned 3044 to the bidder, for example in the form of a well-formatted page posted across the network, itemizing the errors found in the bid. If the bid is valid, as found in step 3043, then the bid is placed 3046 in bid database 2931.

### New Product Forgiveness Program

The exemplary embodiment of the present invention provides an electronic system for customers, on a case-by-case basis, to cancel an existing layaway contract within three months of settlement, return layaway merchandise, and purchase a newer version, or model, of the product without risk of the layaway VPA being placed on hold for additional layaway purchases. The returned layaway merchandise is presented for sale at auction to customers over an electronic network, such as the Internet's World Wide Web, as previously described in the embodiment.

“New Product Forgiveness” program uses payments from a previous layaway contract to establish a new layaway contract to purchase a newer product, or version of an existing product, if the previous contract period is within three months of settlement and the new contract, equal to the costs and fees incurred with the new product contract minus the previous contract payments, can be settled within a new contract period not to exceed three months.

1. A multi-channel retail layaway service whereas registered buyers are provided credit via an on-line virtual payment account to purchase goods specifically for layaway making the retail sale with the registered and non-registered on-line retailers and registered physical retailers final. The sellers do not maintain ownership of the purchased goods during the layaway contract period, i.e., the ordered items are not placed in holding stock, for example, at the physical retail store location.

2. A multi-channel retail layaway service whereas registered buyers are provided credit via an on-line virtual payment account to purchase goods specifically for layaway and the multi-channel retail layaway service allows the buyer to access the virtual payment account via multiple internet connected devices to purchase one or more ordered items from registered sellers and form a layaway contract. The internet connected devices can consist of one or more of the following devices: desktop personal computer, laptop computer, tablet computer, or smartphone.

3. A multi-channel retail layaway service according to claim 1, wherein the layaway purchases do not remain with the sellers for the duration of the layaway contract period but are shipped to a secure storage facility for the duration of the layaway contract period. The purchased items may be stored at the retailer's facility for the duration of the layaway transaction period, e.g., if the purchased item is freight is size.

4. A multi-channel retail layaway service according to claim 1, wherein an on-line retail channel does not have to be linked to the physical or “brick and mortar” retail channel used to form a layaway contract.

5. A multi-channel retail layaway service according to claim 1, wherein the on-line seller or merchant does not have to be registered allowing any and all on-line retailers to conduct retail layaway transactions.

6. A multi-channel retail layaway service according to claim 1, wherein through an issued layaway purchase card (LPC), a registered physical retail channel's point-of-sale (POS) system can be used to access the virtual payment system and form a layaway contract for purchased goods.

7. A multi-channel retail layaway service according to claim 2, wherein through an issued layaway purchase card (LPC), a non-registered on-line retail channel's web server can be used to access the virtual payment system and form a layaway contract for purchased goods.

8. A multi-channel retail layaway service according to claim 2, wherein the charges are applied to the buyer's virtual payment account while simultaneously and automatically deducting a set minimum down payment (e.g., ten percent of retail value plus shipping) by which the layaway transaction is made secure.

9. A multi-channel retail layaway service according to claim 1, that automatically deducts the monthly payments on the remaining retail balance plus layaway and additional shipping fees from a pre-pay, debit or credit account for the duration of the layaway contract period.

10. A multi-channel retail layaway service according to claim 2, that makes canceled layaway transactions available to registered buyers for layaway, direct purchase, or sold via an open on-line auction.

11. A multi-channel retail layaway service that according to claim 1 that offers a “New Product Forgiveness” program whereas payments from a previous layaway contract can be used to establish a new layaway contract to purchase a newer product if the previous contract period is within three months of settlement and the new contract, equal to the costs and fees incurred with the new product contract minus the previous contract payments, can be settled within a new contract period not to exceed three months.
